(19) United States
(12) Patent Application Publication
(10) Pub. No.: US 2012/0095920 A1
(43) Pub. Date: Apr. 19, 2012

(54) METHOD AND APPARATUS FOR FUEL ISLAND AUTHORIZATION FOR TRUCKING INDUSTRY

(75) Inventors: Charles Michael McQuade, Issaquah, WA (US); Brett Brinton, Seattle, WA (US); Rick Fadler, Newcastle, WA (US)

(73) Assignee: Zonar Systems, Inc., Seattle, WA (US)

(21) Appl. No.: 12/906,615

(22) Filed: Oct. 18, 2010

(51) Int. Cl. G06F 21/00; G05B 19/00; H04L 9/32

(52) U.S. Cl. 705/50; 713/168; 340/5.8

(57) ABSTRACT

A fuel authorization system enables data to be exchanged between vehicles and a fuel vendor, to verify that the vehicle is authorized to receive fuel. In an exemplary embodiment, each fuel island is equipped with a motion detector, a short range radio frequency (RF) component, and an infrared (IR) receiver. Participating vehicles are equipped with an IR transmitter and a RF component that can establish a data link with the fuel island's RF unit. When the motion detector senses a vehicle in the fuel lane, an RF query is sent to the vehicle. Participating vehicles respond with an IR transmission. An RF data link is then established between the enrolled vehicle and the fuel vendor to verify that the vehicle is authorized to receive fuel. Once the verification is complete, the fuel dispenser is enabled. If the motion detector senses that the vehicle leaves, the fuel dispenser is disabled.

### BACKGROUND

The trucking industry has an ongoing problem with fuel theft. Trucking companies normally issue fuel cards to drivers. The drivers purchase fuel for company trucks at national refueling chains (i.e., truck stops).

A large problem is that owner operators also frequent such refueling stations. Company drivers often make deals with owner operators to allow the owner operators use of a company fuel card for a cash payment. For example, the owner operator will give the company driver $50 in cash to purchase $150 of fuel on the company fuel card, saving the owner operator $100 in fuel costs. This type of fraud is very difficult for the fleet operators to detect and prevent, because the amount of diverted fuel may be sufficiently small relative to the miles that the fleet vehicle is driven by the driver so as to be difficult to notice, even when fuel use patterns of the vehicle are analyzed.

Some prior art techniques developed to combat this type of fraud have involved placing a radio frequency identification (RFID) tag in the vehicle's fuel tank and an RFID tag reader on the nozzle of the fuel dispenser. Fuel operators dislike this type of system because maintenance of the RFID tag reader on the nozzle of the fuel dispenser is costly and time consuming, and some drivers still attempt to defeat such systems by temporarily removing the RFID tag in the fuel tank, so the tag can be loaned to an owner operator in exchange for a cash payment. Another system relies on RFID tags placed in stickers attached to the windows of the vehicles. Such systems are also not fool proof, because the RFID tags in the windows can be read by readers at the fuel island even when the truck is not immediately adjacent to the fuel dispensing nozzle (i.e., the truck with the RFID tag is nearby, but an unauthorized vehicle is actually at the pump receiving the prepaid fuel), and because such stickers can be easily removed by company drivers and “loaned” to owner operators in exchange for a fraudulent cash payment.

It would therefore be desirable to provide a more secure method and apparatus for implementing fuel authorization in the trucking industry that actually prevents owner operators from stealing fuel charged to a fleet operator account.

### SUMMARY

The concepts disclosed herein are directed to a method to enable an operator of vehicle refueling stations to automatically authorize the refueling of a specific vehicle, such that once the authorization is provided, the fuel being dispensed cannot easily be diverted to a different vehicle. The method involves elements on the vehicle, elements on the fuel island, and a controller (such as a computing device) that receives data from both the fuel island and the vehicle. A sensor element at the fuel island detects when a vehicle enters and leaves a specific fuel island or fuel lane. The fuel islands can be configured such that only one vehicle can readily be accommodated to receive fuel at the fuel island. When a vehicle enters a specific fuel island, the sensor element indicates to a system controller that a vehicle is present. Then, a wireless query is sent to the vehicle, to determine if the vehicle has been equipped to participate in the automated fuel authorization process. If the vehicle is not so equipped, then fuel must be paid for using alternate techniques, such as by using cash or a credit card. If the vehicle is equipped to participate in the fueling authorization technique, then the vehicle wirelessly responds to the query, with a response that includes data specifically identifying that specific vehicle. The system controller queries a local or remote database to determine if that specific vehicle is authorized to receive fuel. If so, the fuel dispenser is enabled and the vehicle is refueled. The system controller generates a data record defining the quantity of fuel delivered, and the record can also include the date, time, and location of the refueling. If the sensor detects that the vehicle has exited the fuel island after the fuel dispenser is enabled but before the fuel is dispensed, the authorization is canceled to prevent the fuel from being dispensed to a non-authorized vehicle. Sensors can include weight sensors, and motion sensors. Some motion sensors detect changes in temperature, while other motion sensors are based on detecting a change in a distance between the sensor and a reflective surface (ultrasonic sensors can be used for this function). The latter type of motion sensors are sometimes referred to as range finders.

In an exemplary embodiment, multiple wireless communication links are established between the fuel island and the vehicle, to ensure that the vehicle authorized to receive the fuel is actually at the fuel island, and not merely close by. In this exemplary embodiment, when the fuel island sensor detects that a vehicle has entered the refuel lane, a radiofrequency (RF) transmitter proximate the fuel island pings (i.e., transmits a query to) the vehicle indicating that the sensor detected the vehicle entering the fuel island. If the vehicle is enrolled in the fuel authorization program, the vehicle will have an RF receiver and transmitter that can communicate with the RF receiver/transmitter associated with the fuel island. It is recognized that an RF transmission, even if at relatively low power and short range, is likely to carry over a wider range than simply the distance between a vehicle in a refuel lane and a fuel dispenser serving that fuel lane. Accordingly, at least one exemplary embodiment employs an additional wireless data link between the answering vehicle and the fuel island. The additional wireless data link ensures that the enrolled vehicle answering the RF query that was sent in response to fuel island sensor detecting a vehicle entering a specific refuel lane is really the vehicle in the specific refuel lane and not in a different refuel lane (or not in any refuel lane, but simply in the vicinity of the fuel island). In this exemplary embodiment, the additional wireless data link is established using infrared (IR) transmitters and receivers, which are more directional than RF communication (and when low power light emitting diodes are used as an IR source, the IR transmission can have a short range). Thus, in this exemplary embodiment, in response to an RF query from the fuel island, the enrolled vehicle will initially responds by directing an IR-based communication toward the fuel island. The IR receiver associated with each refuel lane is positioned such that the IR receiver will only be able to receive an IR signal from an IR transmitter actually positioned in that specific refuel lane, verifying that the enrolled vehicle responding to the fuel island's RF query is really the vehicle in the refuel lane for which the RF query originated. Once the location of the enrolled vehicle is confirmed, RF communication between the fuel island (or the fuel vendor operating the fuel island, in embodiments where the RF component is not located on the fuel island) is enabled, and the enrolled vehicle provides identification data to the fuel island. The vehicle's identification data are unique to that specific vehicle.

In at least one of the embodiments disclosed herein, simply moving a component that was added to each enrolled vehicle to enable the vehicle to participate in the fuel authorization program and installing that component on a non-authorized vehicle will not enable the non-authorized vehicle to participate in the fuel authorization program, because the added component does not itself store all the data required to enable fuel authorization. Instead, the component is configured to retrieve some of the required data from a vehicle memory that is not part of the component. Since the non-authorized vehicle will not include the memory storing the required data, simply moving the component to a different vehicle will be insufficient to enable the different vehicle to participate in the fuel authorization program. In some exemplary embodiments, the required information that is stored in the memory and not in the component is a vehicle ID number, such as VIN # (i.e., a vehicle identification number). In some exemplary embodiments, the required information is a password or encryption key. In other exemplary embodiments, the required information includes both a vehicle ID number and a password/encryption key. In some exemplary embodiments, the memory in which at least some of the verification data is stored is memory that is not readily removable from the vehicle. The term not readily removable is intended to refer to memory that requires a significant amount of effort to remove from the vehicle. This aspect of the concepts disclosed herein is intended to deter drivers from attempting to temporarily remove a component used in the fuel authorization program and lend that component to another vehicle, to enable a non-authorized vehicle to receive fuel using the fuel authorization program. For example, some fuel authorization programs attempted to deploy radiofrequency (RFID) tags on enrolled vehicles, such that when an RFID tag reader at a fuel pump read an enrolled RFID tag, the pump was enabled. Such a fuel authorization program is easily circumvented by drivers who would temporarily remove the RFID tag (which was generally attached to the windshield of the vehicle) and loan the RFID tag to a non-participating vehicle. By including some data component required to complete the fuel authorization process in a memory that is not readily removable from the vehicle, it will be much more difficult for drivers to circumvent the fuel authorization program. In an exemplary embodiment, the required data is stored in a memory that requires an hour or more of time to remove from the vehicle.

Once the verification is accepted by the fuel island, the fuel dispenser is enabled, and the vehicle can be refueled. If the fuel island sensor detects that the enrolled vehicle has moved away from the fuel island (perhaps to let an unauthorized vehicle be positioned receive fuel from the enabled fuel dispenser), the fuel dispenser is immediately disabled.

In at least one exemplary embodiment, during the RF communication between the enrolled vehicle and the fuel island, data from the vehicle (including but not limited to accumulated mileage, accumulated engine hours, and in some embodiments, a quantity of fuel present in the vehicle's fuel tanks) are transferred from the vehicle to the fuel vendor over the RF data link. That data can then be used to audit the vehicle's fuel usage, and to detect fuel fraud that could occur if a driver allows authorized fuel to be siphoned or otherwise removed from the vehicle, rather than be consumed by that vehicle. Additional data, not related to the fuel authorization program, can also be conveyed over the RF data link between the vehicle and the fuel vendor, if desired.

In other exemplary embodiments discussed below, the vehicle detection sensor is eliminated, and the RF data link between the fuel vendor and the enrolled vehicle is initiated after an IR data link between the fuel island and the vehicle is established. Where the vehicle includes an appropriately configured telematics unit, the telematics unit can be used to collect data showing the vehicle has not moved away from the fuel island, and that data can be conveyed in real-time to the fuel vendor (in this case, the fuel dispenser, once enabled, remains enabled until the real-time data transfer showing the vehicle has not moved relative to the fuel island ceases, or such data indicates that the vehicle has moved away from the fuel island).

Other aspects of the concepts disclosed herein are directed to a memory medium that stores machine instructions, which when executed by a processor, carries out substantially the same functions described above, and by a system. In such systems, the basic elements include an enrolled vehicle having two different data link components, at least one of which is highly directional and/or short ranged, a computing device programmed to automatically determine if a specific enrolled vehicle is authorized to be refueled, and a fuel island that includes: (1) a sensor for detecting the presence of a vehicle in a specific refuel lane; (2) access to a relatively longer range data link component; and, (3) a highly directional and/or short range data link component used to verify the presence of a specific enrolled vehicle in a specific refuel lane. It should be recognized that these basic elements can be combined in many different configurations to achieve the exemplary concepts discussed above. Thus, the details provided herein are intended to be exemplary, and not limiting on the scope of the concepts disclosed herein. Systems disclosed herein that employ vehicle telematics units that replace the need for the fuel island sensor, will be configured differently, generally consistent with the details of such embodiments provided below. It should be recognized that the term processor and controller as used herein refer to a component configured to implement specific functions.

The above noted methods are preferably implemented by at least one processor (such as a computing device implementing machine instructions to implement the specific functions noted above) or a custom circuit (such as an application specific integrated circuit).

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIGS. 1A-1D are high level logic diagrams illustrating how certain elements implemented in some of the exemplary embodiments of the fuel authorization concepts disclosed herein address selected design parameters of those concepts;

FIG. 2A is a logic diagram showing exemplary overall method steps implemented in a first exemplary embodiment for implementing a fuel authorization method;

FIG. 2B is a logic diagram showing exemplary method steps implemented in a second exemplary embodiment for implementing a fuel authorization method;

FIG. 3 is a functional block diagram of an exemplary computing device that can be employed to implement some of the method steps disclosed herein;

FIG. 4 is an exemplary functional block diagram showing the basic functional components used to implement the method steps of FIG. 2B;

FIG. 5 is an exemplary functional block diagram showing some of the basic functional components used to collect fuel use data from a vehicle;

FIG. 6 is a logic diagram showing exemplary overall method steps implemented in at least some of the fuel authorization methods disclosed herein, where fuel use data extracted from the vehicle are used to determine if possible fraud has occurred;

FIG. 7 is another exemplary functional block diagram showing the basic functional components used to implement the method steps of FIG. 2B, wherein most of the components used by the fuel vendor to implement the method are disposed proximate each fuel dispenser;

FIG. 8 schematically illustrates vehicle components and fuel island components used to implement the method steps of FIG. 2B;

FIG. 9 is a logic diagram showing exemplary method steps implemented in a third exemplary embodiment for implementing a fuel authorization method, wherein the third exemplary embodiment is closely related to the method steps of FIG. 2B;

FIG. 10 is a logic diagram showing exemplary method steps implemented in a fourth exemplary embodiment for implementing a fuel authorization method;

FIG. 11 is a logic diagram showing exemplary method steps implemented in a fifth exemplary embodiment for implementing a fuel authorization method;

FIG. 12 schematically illustrates vehicle components and fuel island components used to implement the method steps of FIG. 11;

FIG. 13 is a functional block diagram of an exemplary telematics device added to an enrolled vehicle to implement some of the method steps of FIG. 11; and

FIG. 14 is a functional block diagram illustrating how data collected in the fuel authorization methods disclosed herein can be shared among various parties.

### DESCRIPTION

### Figures and Disclosed Embodiments Are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

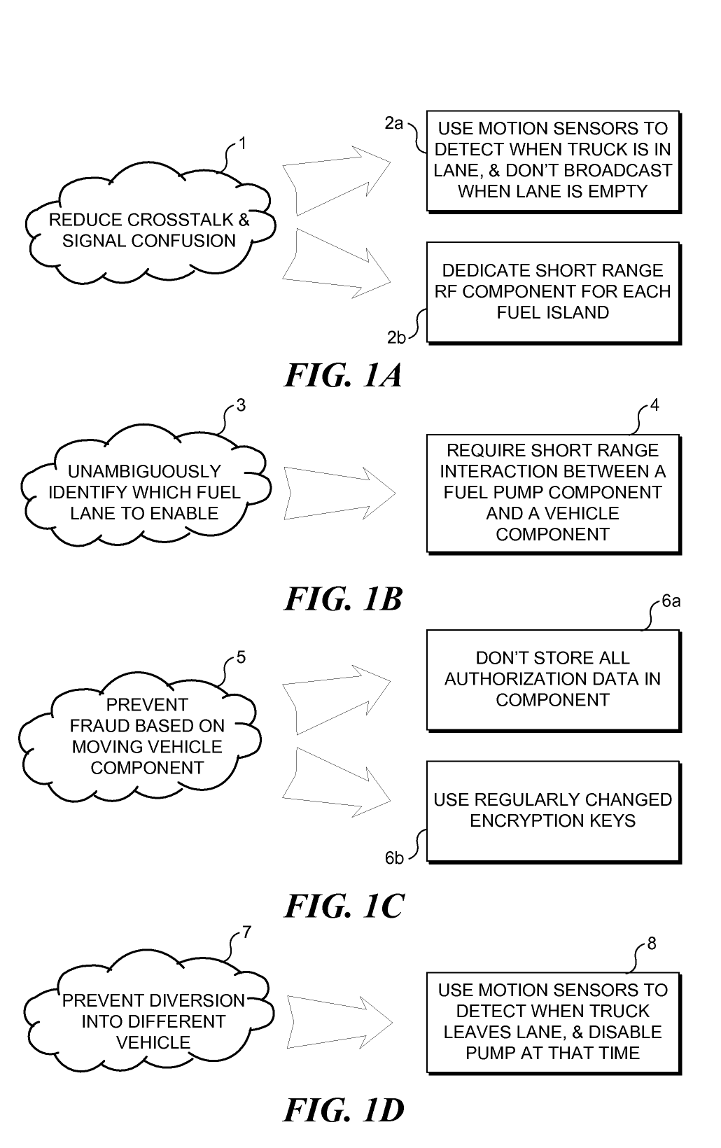

FIGS. 1A-1D are high level logic diagrams illustrating how certain elements of the present novel fuel authorization concepts are implemented in some of the exemplary embodiments to address design goals. It should be understood that not each of the design goals discussed in the context of FIGS. 1A-1D are achieved in each and every embodiment disclosed herein Rather, FIGS. 1A-1D provide context with respect to problems identified by applicants with regard to prior art fuel authorization programs, and indicate how such problems have been addressed by the concepts disclosed herein. Each embodiment disclosed herein solves one or more of the problems identified in FIGS. 1A-1D.

In FIG. 1A, a thought bubble 1 indicates that applicants have recognized that crosstalk and signal confusion can be a problem in fuel authorization programs. Many fuel vendors operate facilities with multiple fuel islands. As used herein and in the claims that follow, the term “fuel island” is intended to refer to an area designated for vehicles to park while the vehicle is being refueled. A fuel island will include a fuel dispenser (similar to the ubiquitous fuel pumps that are familiar to every driver), and often, but not always, will be covered by a canopy to protect the driver from rain during refueling. In general, a single fuel island can be designed to accommodate a single vehicle, but some vendors operate refueling facilities with two-side fuel dispenser, with a fuel dispenser for each side. In such a dual side configuration, each side of the fuel island is a different fuel lane, and for the purposes of understanding the concepts discussed herein and as used in the claims that follow, each side of a dual-side fuel dispenser should be considered to be a different fuel island. Good design practice is to configure such dual side-fuel dispenser so that hoses used for the each fuel dispenser (i.e., on one side) are too short to refuel a vehicle parked on the opposite side of the fuel dispenser. Referring once again to FIG. 1A, one concern defined in developing the concepts disclosed herein was that vendors operating stations with multiple fuel islands (or multiple fuel lanes) can refuel a number of vehicles simultaneously. If wireless technology is employed to enable the fuel vendor to communicate with vehicles in the fuel authorization program, then many different wireless signals could be occurring at about the same time. Participants in fuel authorization programs are very concerned with ensuring that authorized fuel only be dispensed to approved vehicles, and that signal confusion or crosstalk may lead to fuel authorized for delivery at one fuel dispenser being actually dispensed into an unauthorized vehicle parked at a different fuel dispenser. Blocks 2a and 2b indicate solutions for the problem identified in thought bubble 1, which are incorporated into at least some of the concepts disclosed herein. In block 2a, one solution employed in at least some embodiments disclosed herein to address the signal confusion/cross talk concern is to incorporate a motion sensor at each fuel dispenser, to detect when a vehicle enters a fuel lane serviced by that fuel dispenser. Wireless signals for managing the fuel authorization program will not be generated unless a fuel lane serviced by that fuel dispenser is occupied by a vehicle. Thus, the volume of wireless signal traffic will be reduced whenever a fuel lane is vacant. Various types of motion sensors can be employed, including optical-based systems, acoustical based systems, and combined systems that use both optics and acoustics. A weigh scale (or other form of pressure sensor) can be included in the fuel lane to detect the weight of a vehicle; however, installation and maintenance of such a scale will likely far exceed the installation and maintenance costs for a motion detector. In an exemplary embodiment, an ultrasonic sensor is used to monitor a distance between the sensor and a reflective surface. When no vehicle is present, the reflective surface is the ground. When a vehicle enters the fuel lane, the reflective surface is a roof of the vehicle (either a cab of the vehicle or tractor, or the roof of a trailer or cargo area of the vehicle). This type of ultrasonic sensor is encompassed by the use of the term motion sensor, as at least some types of motion sensors detect changes in a distance between the sensor and a reflective surface.

In block 2b, another solution employed in at least some embodiments disclosed herein to address the signal confusion/cross talk concern is to include a short range RF transmitter/receiver component proximate each different fuel dispenser. If the entire refueling facility is served by a common RF transmitter/receiver component used to manage wireless communications for managing the fuel authorization program across multiple fuel dispensers, then there will be a greater chance that signals originating proximate one specific fuel dispenser can be confused with signals originating proximate a different fuel dispenser. The use of short range (i.e., low power) RF will greatly reduce the likelihood of such signal confusion, since signals from different fuel islands are much less likely to interfere with one another.

In FIG. 1B, a thought bubble 3 indicates a recognition that unambiguously identifying the specific one of a plurality of different fuel dispensers that should be enabled to refuel a specific enrolled vehicle is very important. While many prior art systems have attempted to address this issue, it is significant that very few prior art fuel authorization programs have been accepted in the marketplace, and a significant barrier to entry for any new fuel authorization method is convincing participants that the proposed system is an improvement over existing systems. Currently, the most widely accepted fuel authorization program is based on distributing magnetic cards to drivers, who use them like credit cards at fuel pumps to authorize refueling transactions. Large thefts of fuel can be tracked by historical analysis (matching up miles driven with fuel use), but small thefts (i.e., of about 30 gallons or less) are harder to track, as fuel mileage can and does vary, and over the course of thousands of miles such small volumes of diverted fuel are easy to miss. While participants in fuel authorization programs would embrace a system that could prevent such small volume thefts (which can accumulate over time into large dollar losses), such participants also recognize that if hundreds of gallons of fuel (large trucks have fuel capacities of 250-300 gallons) are mistakenly dispensed to the wrong vehicle, such losses can exceed the small volume diversions that occur in the present magnetic card based system. In a block 4, this concern is addressed by requiring an interaction between a component on (or proximate to) the vehicle to be refueled and a component on (or proximate to) the fuel dispenser, for the refueling authorization to proceed. Note that this interaction is not the only requirement to enable fuel authorization to be provided, but this element is present in each disclosed embodiment, to ensure the correct fuel dispenser is enabled.

In FIG. 1C, a thought bubble 5 indicates the recognition that preventing fraud based on moving a component that is required to enable refueling transactions to be approved, so that the component is disposed in a different vehicle, is a concern that needed to be addressed. In each of the embodiments as disclosed herein, the vehicle includes at least one component that is employed during the authorization process. Blocks 6a and 6b indicate solutions for preventing the required component from being removed from an authorized vehicle and being moved to an unauthorized vehicle, to enable the unauthorized vehicle to receive fuel. In block 6a, one solution employed in at least some of the embodiments disclosed herein to address this issue is to ensure that not all of the data required to complete the authorization transaction are stored in the required vehicular component, so that if the required vehicular component is removed from the authorized vehicle, the presence of the vehicular component alone in an unauthorized vehicle will not enable the unauthorized vehicle to receive fuel. In block 6b, one solution employed in at least some embodiments disclosed herein to address the problem of removing a required component from an authorized vehicle to a non-authorized vehicle is requiring the fuel vendor and the authorized vehicle to have access to passwords or encryption keys that are changed on a regular basis. Thus, even if someone who stole the required component from an enrolled vehicle managed to determine the additional data required to enable a transaction to be authorized, that stolen component would have a limited useful life without updated encryption codes/passwords.

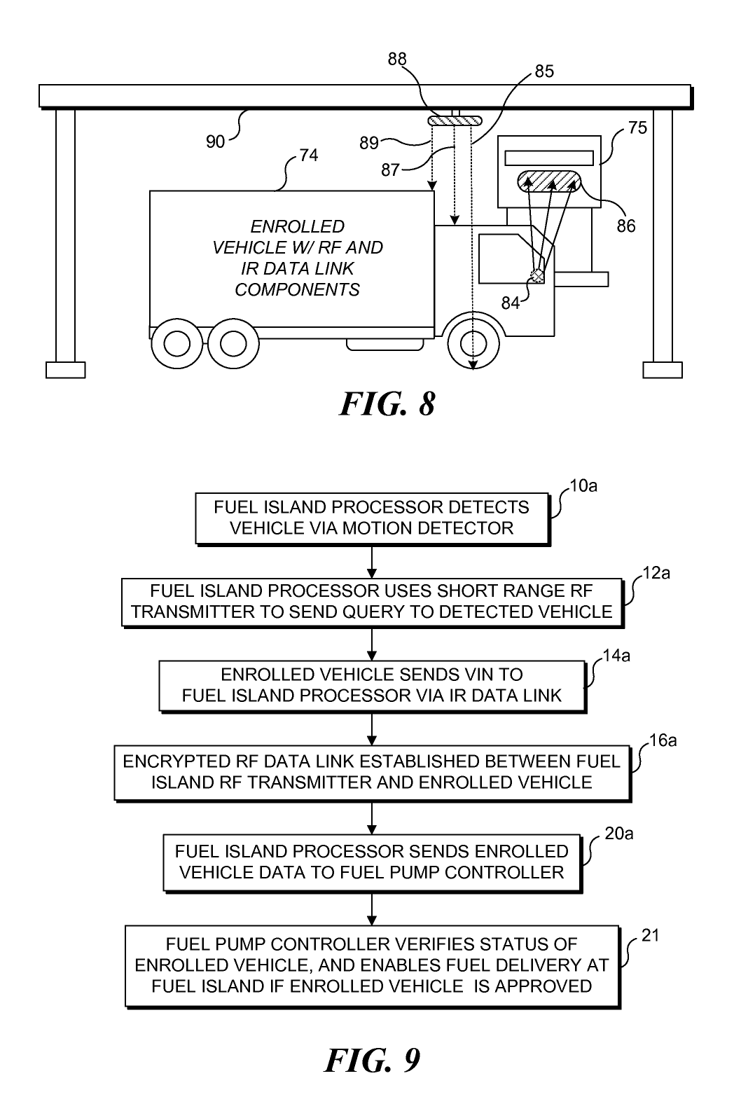

In FIG. 1D, a thought bubble 7 indicates it is recognized that preventing fraud based on moving the authorized vehicle away from the fuel dispenser after the fuel dispenser has been enabled (thus allowing a non-authorized vehicle to move into the fuel lane to receive the authorized fuel) is a concern that should be addressed. A block 8 indicates that a solution for the problem identified in thought bubble 7, which is incorporated into at least some of the concepts disclosed herein, is to use motion sensors to detect when the authorized vehicle moves away from the fuel dispenser. Once such motion is detected, the enabled fuel dispenser is shut off, to prevent the fuel from being diverted into a non-authorized vehicle moving into the fuel lane. In at least some embodiments, a certain amount of motion is allowed, in case a driver needs to reposition the authorized vehicle slightly to ensure the fuel dispenser can physically reach the vehicle's fuel tanks. In at least one embodiment discussed below in connection with FIG. 8, the motion sensor/range finder can be used to collect data that can be used to allow some degree of acceptable motion.

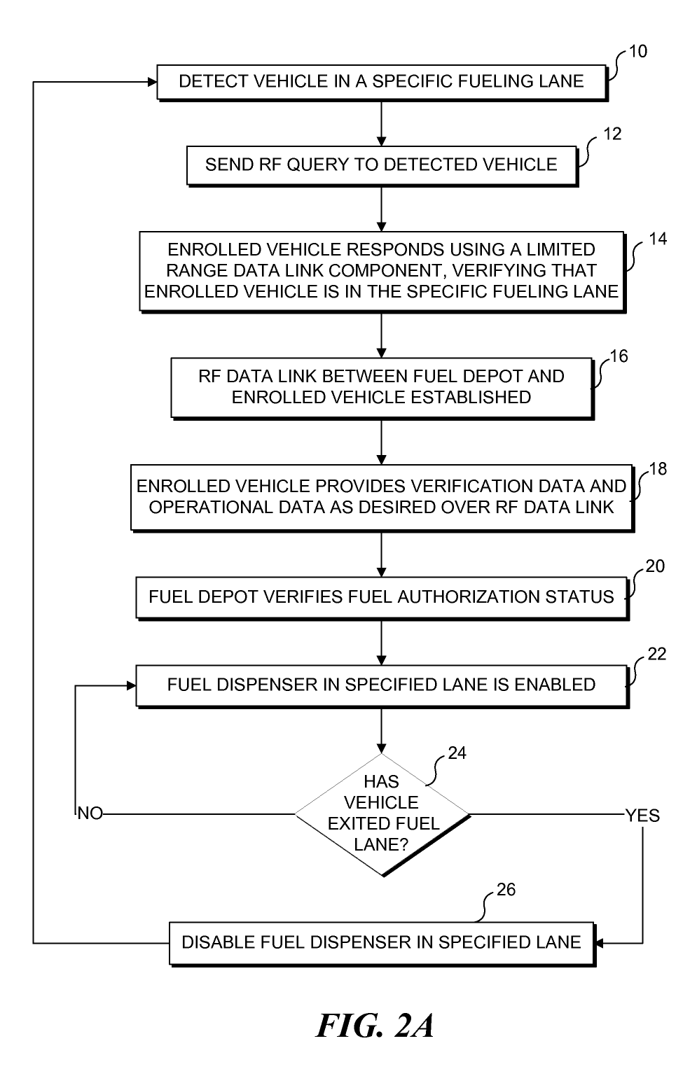

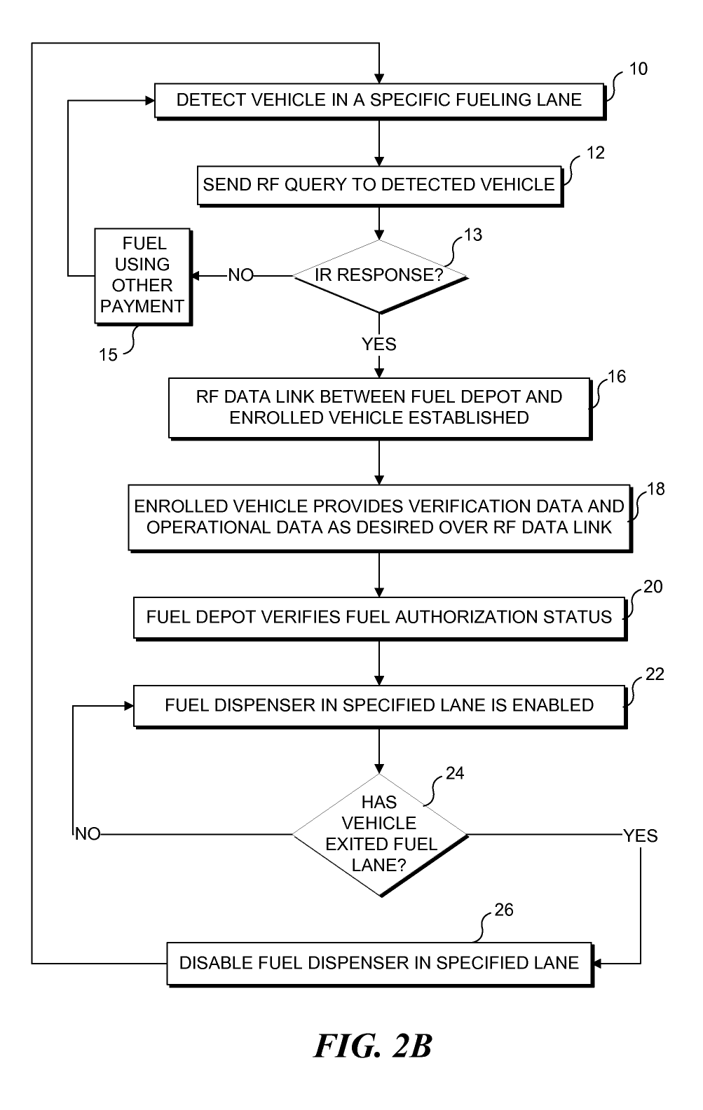

FIG. 2A is a logic diagram showing exemplary overall method steps implemented in a first exemplary embodiment for implementing a fuel authorization method in accord with the concepts disclosed herein. Referring to FIG. 2A, in a block 10, a vehicle is detected moving into an empty fuel lane (i.e., a vehicle is detected moving adjacent to a specific fuel pump or fuel dispenser, wherein the phrase “moving adjacent to” should be understood as moving the vehicle into a position appropriate to enable the vehicle to be refueled, understanding that some slight repositioning maybe required to accommodate specific fuel tank positions). As noted above, in exemplary embodiments, motion detectors will be employed to implement the step of block 10, although it should be recognized that other types of sensors (including but not limited to, scales responding to a weight of the vehicle, and metal detectors responding to the mass of metal in a vehicle) can also be employed. In a block 12, an RF query is generated to interrogate the detected vehicle. If the vehicle fails to respond to the RF query, it will be assumed that the vehicle is not enrolled in the fuel authorization program, and payment will be required in some other form (enrolled vehicles may fail to respond due to a fault of some kind, and unless the fault is readily correctable, such vehicles will also be required to pay in some other way). In a block 14, enrolled vehicles whose fuel authorization program components are functioning properly respond to the RF query using a limited range (and/or highly directional) data link component directed to a receiver disposed proximate to the fuel dispenser, thereby initially verifying that the vehicle is an enrolled vehicle, and identifying from which fuel dispenser the vehicle wishes to acquire fuel. Several different limited range data links can be established, including an IR based data link (which is range limited and directional), and a short range

RF based data link (which is range limited and/or unidirectional; noting that this embodiment encompasses RFID tag implementations). Note that block 14 is considered to be an initial verification, in the sense that the fuel dispenser is not yet enabled, because additional verification steps are required to prevent fuel from being dispensed to unauthorized parties.

In a block 16, an RF data link between the fuel vendor and the detected vehicle is established, to facilitate further verification, as well as to enable the vehicle to convey operational and additional data as desired (transmission of data other than that required for verification purposes is not required, although many users may find that ability desirable). In at least some embodiments encompassed herein, the RF data link is encrypted, such that the data transferred cannot be read without the proper key. Password exchange between the vehicle and the fuel vendor RF components can also be used to prevent RF data links from being established with non-authorized vehicles. The term “fuel vendor” as used in this context should be understood to refer to the entity operating the fuel dispensers, as opposed to a specific location. In at least some embodiments disclosed herein, the fuel vendor employs a single RF component to support fuel authorization transactions across multiple fuel dispensers/fuel lanes at a fuel depot or refueling facility, while in other embodiments disclosed herein each fuel dispenser/fuel lane participating in the refueling authorization program at a fuel depot is equipped with a dedicated RF component, which in some exemplary embodiments, is a very low powered, short range component, to reduce crosstalk and signal confusion across multiple fuel islands.

In a block 18, the vehicle uses the RF data link to convey verification data to the fuel vendor, along with any additional data that are desired. Exemplary, but not limiting types of additional data (i.e., data beyond that specifically required to enable verification for fuel delivery authorization) include fuel use related data (vehicle mileage, engine hours, fuel tank level, idle time data, etc.), operational data (such as fault codes), and driver specific data (driver ID, driver hours for DOT compliance and/or payroll). Any data collected by the vehicle can be transferred over the RF data link. Data not required by the fuel vendor can be conveyed to other parties, generally as discussed below in connection with FIG. 15.

Referring once again to FIG. 2A, in a block 20, the fuel vendor verifies that the vehicle is authorized to participate in the fuel authorization program. It should be recognized that the step of block 20 may include multiple components. For example, in at least some of the embodiments disclosed herein, an offsite database may be queried before enabling fuel delivery (much as occurs in the approval of a credit card transaction), and in at least some other embodiments disclosed herein, the verification data are passed to a fuel pump controller that handles all fuel dispenser enablement functions (regardless of whether payment is via a credit card or the fuel authorization program). Once the authorization is approved, the fuel dispenser to which the vehicle is adjacent is enabled in a block 22, and the enrolled vehicle can be refueled. After the fuel dispenser has been enabled, the sensor in the fuel lane is monitored to determine if the enrolled vehicle has moved out of the fuel lane, as indicated in a decision block 24. If no motion (or no more than a predefined permitted amount of motion consistent with adjusting the vehicle's position relative to the fuel dispenser to better enable the fuel dispenser to reach the vehicle's fuel tanks) is detected, then the logic loops back to block 22 and the fuel dispenser remains enabled. If motion (or more than the predefined amount of motion consistent with slightly adjusting the vehicle's position relative to the fuel dispenser to enable the fuel dispenser to better reach the vehicle's fuel tanks) is detected, then in a block 26, the fuel dispenser is disabled, and the process is repeated when another vehicle is detected entering the fuel lane.

FIG. 2B is a logic diagram showing exemplary method steps implemented in a second exemplary embodiment for implementing a fuel authorization method in accord with the concepts disclosed herein. Steps that have not changed relative to the exemplary steps of FIG. 2A maintain the same reference numbering. Referring to FIG. 2B, in block 10, a vehicle is detected moving into an empty fuel lane (i.e., a vehicle is detected moving adjacent to a specific fuel pump or fuel dispenser, wherein the phrase “moving adjacent to” should be understood to mean moving the vehicle into a position appropriate to enable the vehicle to be refueled, understanding that some slight repositioning maybe required to accommodate specific fuel tank positions). In block 12, an RF query is generated to interrogate the detected vehicle. In a decision block 13, it is determined whether the detected vehicle has properly responded to the RF query by transmitting an IR response to an IR receiver disposed proximate the fuel dispenser. As discussed below, in at least some embodiments, components are added to enrolled vehicles to help drivers determine if a vehicle is properly positioned to enable the IR transmission required for fuel delivery authorization. Referring once again to decision block 13, if no IR response has been received, the vehicle is either not enrolled or is improperly positioned, and fueling will not be enabled unless some other form of payment is made, as indicated in a block 15. If an appropriate IR response is received in decision block 13, then in block 16, an RF data link between the fuel vendor and the detected vehicle is established, to facilitate further verification, as well as to enable the vehicle to convey operational and any additional data as desired. In block 18, the vehicle uses the RF data link to convey verification data to the fuel vendor, along with any additional data desired. In block 20, the fuel vendor verifies that the vehicle is authorized to participate in the fuel authorization program. Once the authorization is approved, the fuel dispenser to which the vehicle is adjacent is enabled in block 22, and the enrolled vehicle can be refueled.

After the fuel dispenser has been enabled, the sensor in the fuel lane is monitored to determine if the enrolled vehicle has moved out of the fuel lane, as indicated in decision block 24. If no motion (or no more than a predefined amount of motion consistent with adjusting the vehicle's position relative to the fuel dispenser to enable the fuel dispenser to better reach the authorized vehicle's fuel tanks) is detected, then the logic loops back to block 22, and the fuel dispenser remains enabled. If excessive motion (more than the predefined amount of motion consistent with adjusting the vehicle's position relative to the fuel dispenser to enable the fuel dispenser nozzle to more efficiently reach the authorized vehicle's fuel tanks) is detected, then in a block 26, the fuel dispenser is disabled. The process is repeated when another vehicle is detected entering the fuel lane.

Significantly, the method of FIG. 2B requires that the response from the vehicle to the RF query is an IR-based response. In contrast to using an RF data link to respond to the initial RF query, the use of an IR data link (which is directional in addition to short range) provides an additional level of insurance to the participants of the fuel authorization program that there will be no confusion as to which fuel dispenser is to be enabled for a specific participating vehicle (since a plurality of enrolled vehicles may be refueling at the same fueling vendor location at about the same time). It is believed that this additional insurance will lead to such an embodiment having greater potential acceptance in the market, by easing potential user fears that fuel authorizations will be misapplied.

Note that when an IR receiver at a particular fuel dispenser receives an IR transmission from an enrolled vehicle, the fuel vendor unambiguously knows which fuel dispenser should be enabled (if additional verification checks are successful). The IR transmission does not need to include any data at all, as receipt of the IR signal itself identifies the fuel dispenser that should be subsequently enabled. However, in many embodiments, some actual data will be conveyed over the IR data link. In at least some embodiments, the IR response from the vehicle will uniquely identify a specific vehicle. In an exemplary, but not limiting embodiment, the IR transmission includes the vehicle's VIN, sent in an unencrypted form. In other embodiments, the IR transmission includes a random string and a time variable. In this embodiment, to increase the speed of data transfer (recognizing that IR data transfer is not particularly fast), the initial RF query from the pump includes a random alphanumeric string of less than 17 digits (VINs generally being 17 digits, so the random string will be shorter, resulting in faster IR data transfer as compared to embodiments in which the IR response from the vehicle was based on transmitting the vehicle's VIN over the IR data link in response to the RF query from the fuel vendor). The vehicle will then reply to the fuel vendor's RF query by transmitting the less than 17 character random string via IR. The fuel island will only accept an IR return of the random string for a limited period of time (to prevent another party from eavesdropping and obtaining the random string, and attempting to use the random string themselves). The period of time can vary, with shorter time periods making it more difficult for another party to use the random string. In an exemplary but not limiting embodiment, the time period is less than five minutes, and in at least one embodiment is less than about 90 seconds, which should be sufficient for an enrolled vehicle to properly position itself relative to the IR receiver. In at least some embodiments, the IR data will include at least one data component that is obtained from a memory in the vehicle that is not readily removable, such that simply removing the IR transmitter from an enrolled vehicle and moving the IR transmitter to a non-authorized vehicle will not enable the non-authorized vehicle to receive fuel.

Certain of the method steps described above can be implemented automatically. It should therefore be understood that the concepts disclosed herein can also be implemented by a controller, and by an automated system for implementing the steps of the method discussed above. In such a system, the basic elements include an enrolled vehicle having components required to facilitate the authorization process, and a fuel vendor whose fuel lanes/fuel dispensers include components that are required to facilitate the authorization process as discussed above. It should be recognized that these basic elements can be combined in many different configurations to achieve the exemplary concepts discussed above. Thus, the details provided herein are intended to be exemplary, and not limiting on the scope of the concepts disclosed herein.

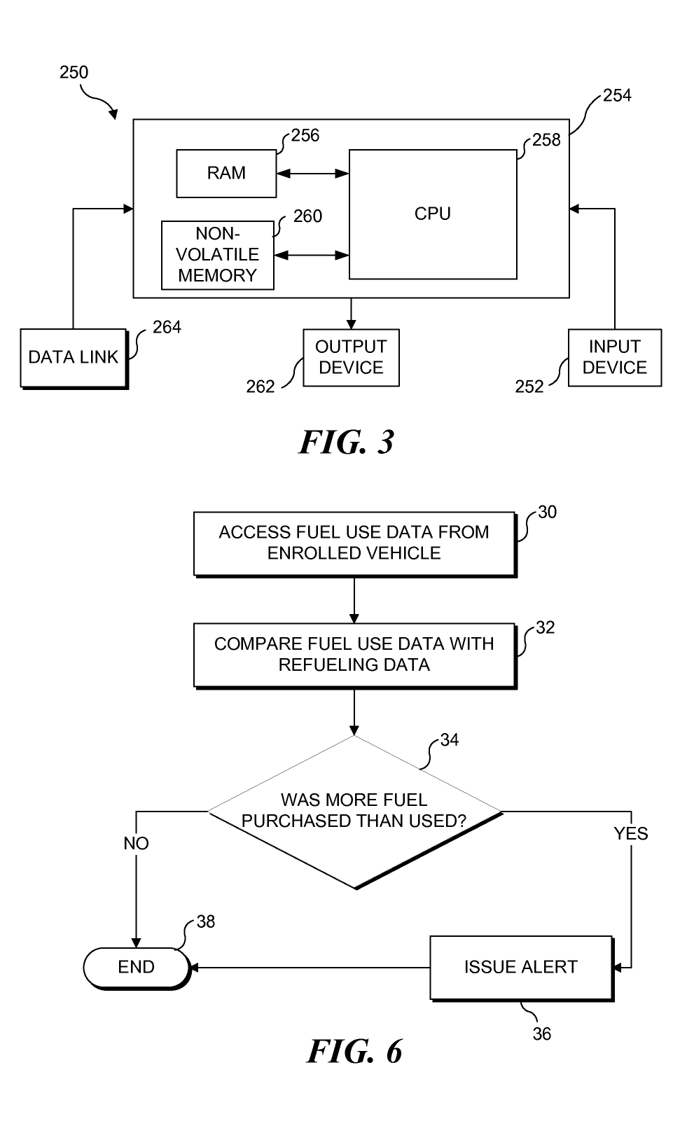

Steps in the methods disclosed herein can be implemented by a processor (such as a computing device implementing machine instructions to implement the specific functions noted above) or a custom circuit (such as an application specific integrated circuit). FIG. 3 schematically illustrates an exemplary computing system 250 suitable for use in implementing certain steps in the methods of FIGS. 2A and 2B (i.e., for executing at least blocks 12, 16, 20, 22, 24, and 26 of FIG. 2A, and at least blocks 12, 13, 16, 20, 22, 24, and 26 of FIG. 2B). It should be recognized that different ones of the method steps disclosed herein can be implemented by different processors (i.e., implementation of different ones of the method steps can be distributed among a plurality of different processors, different types of processors, and processors disposed in different locations). Exemplary computing system 250 includes a processing unit 254 that is functionally coupled to an input device 252 and to an output device 262, e.g., a display (which can be used to output a result to a user, although such a result can also be stored for later review or analysis). Processing unit 254 comprises, for example, a central processing unit (CPU) 258 that executes machine instructions for carrying out at least some of the various method steps disclosed herein, such as establishing, processing, or responding to RF or IR signals. The machine instructions implement functions generally consistent with those described above (and can also be used to implement method steps in exemplary methods disclosed hereafter). CPUs suitable for this purpose are available, for example, from Intel Corporation, AMD Corporation, Motorola Corporation, and other sources, as will be well known to those of ordinary skill in this art.

Also included in processing unit 254 are a random access memory (RAM) 256 and non-volatile memory 260, which can include read only memory (ROM) and may include some form of memory storage, such as a hard drive, optical disk (and drive), etc. These memory devices are bi-directionally coupled to CPU 258. Such storage devices are well known in the art. Machine instructions and data are temporarily loaded into RAM 256 from non-volatile memory 260. Also stored in the non-volatile memory may be an operating system software and other software. While not separately shown, it will be understood that a generally conventional power supply will be included to provide electrical power at voltage and current levels appropriate to energize computing system 250.

Input device 252 can be any device or mechanism that facilitates user input into the operating environment, including, but not limited to, one or more of a mouse or other pointing device, a keyboard, a microphone, a modem, or other input device. In general, the input device might be used to initially configure computing system 250, to achieve the desired processing (i.e., to compare subsequently collected actual route data with optimal route data, or to identify any deviations and/or efficiency improvements). Configuration of computing system 250 to achieve the desired processing includes the steps of loading appropriate processing software into non-volatile memory 260, and launching the processing application (e.g., loading the processing software into RAM 256 for execution by the CPU) so that the processing application is ready for use. Output device 262 generally includes any device that produces output information, but will typically comprise a monitor or display designed for human visual perception of output. Use of a conventional computer keyboard for input device 252 and a computer monitor for output device 262 should be considered as exemplary, rather than as limiting on the scope of this system. Data link 264 is configured to enable data collected in connection with operation of a fuel authorization program to be input into computing system 250. Those of ordinary skill in the art will readily recognize that many types of data links can be implemented, including, but not limited to, universal serial bus (USB) ports, parallel ports, serial ports, inputs configured to couple with portable memory storage devices, FireWire ports, infrared data ports, wireless data communication such as Wi-Fi and Bluetooth™, network connections via Ethernet ports, and other connections that employ the Internet. Note that data from the enrolled vehicles will typically be communicated wirelessly (although it is contemplated that in some cases, data may alternatively be downloaded via a wire connection).

It should be understood that the term “computer” and the term “computing device” are intended to encompass networked computers, including servers and client device, coupled in private local or wide area networks, or communicating over the Internet or other such network. The data required to implement fuel authorization transactions can be stored by one element in such a network, retrieved for review by another element in the network, and analyzed by any of the same or yet another element in the network. Again, while implementation of the method noted above has been discussed in terms of execution of machine instructions by a processor (i.e., the computing device implementing machine instructions to carry out the specific functions noted above), at least some of the method steps disclosed herein could also be implemented using a custom circuit (such as an application specific integrated circuit).

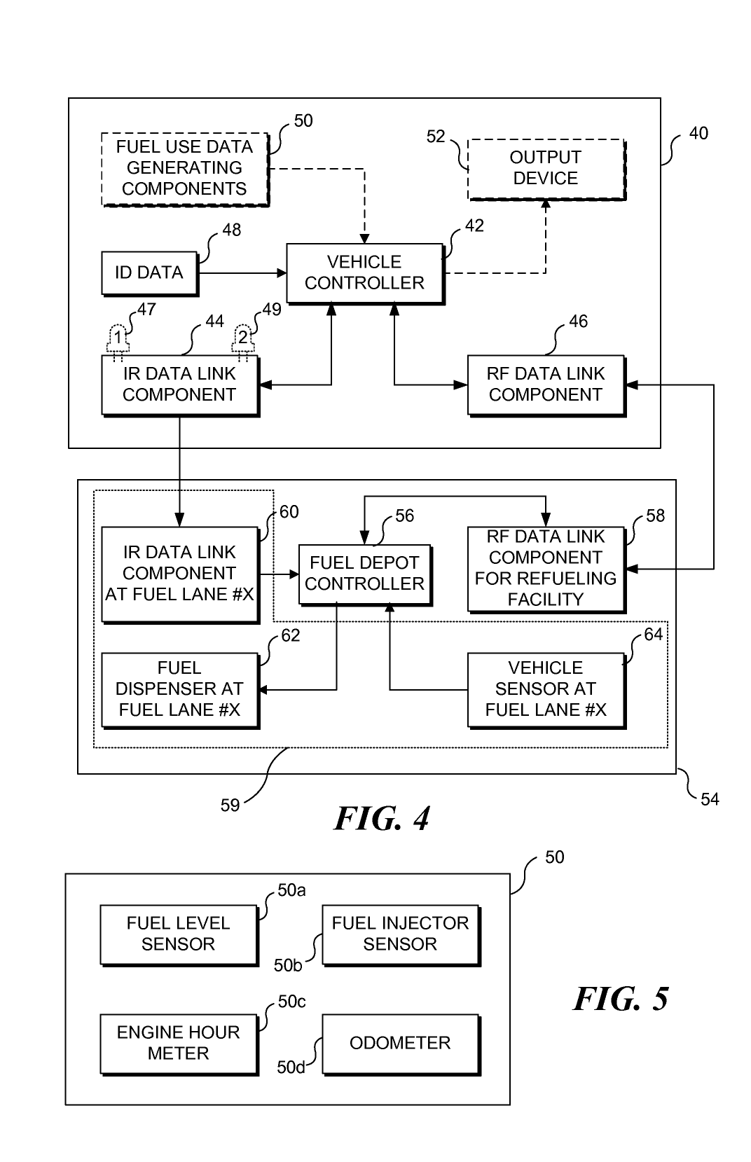

FIG. 4 is an exemplary functional block diagram showing the basic functional components used to implement the method steps of FIG. 2B. Shown in FIG. 4 are an enrolled vehicle 40 and a refueling facility 54. Vehicle 40 includes a vehicle controller 42 implementing functions generally consistent with the vehicle functions discussed above in connection with FIG. 2B (noting that if desired, such functions could be implemented using more than a single controller), an IR data link component 44 (i.e., an IR emitter), an RF data link component 46 (i.e., an RF transmitter and an RF receiver, implemented as a single component or a plurality of separate components), and a memory 48 in which vehicle ID data (and/or fuel authorization verification data) are stored (noting that in some exemplary embodiments, the memory in which such data are stored is not part of a required fuel authorization component, such as a telematics unit, that is added to enrolled vehicles, such that removal of the added component alone is insufficient to enable the removed component to be used in a non-authorized vehicle to participate in the fuel authorization program), each such component being logically coupled to controller 42. In an exemplary embodiment, the IR data link component includes two lights 47 and 49, whose functions is discussed below. Vehicle 40 may also include an optional output device 52 that can be used to provide feedback or instructions relevant to the fuel authorization program to the vehicle operator, and fuel use data generating components 50 (i.e., components that collect data that can be used to calculate an amount of fuel used by the vehicle). Each optional component is logically coupled to the vehicle controller.

Refueling facility 54 includes a fuel depot controller 56 implementing functions generally consistent with fuel vendor functions discussed above in connection with FIG. 2B (noting that if desired, such functions could be implemented using more than a single controller) and an RF data link component 58 (i.e., an RF transmitter and an RF receiver, implemented as a single component or a plurality of separate components) logically coupled to controller 56. Refueling facility 54 will likely include a plurality of fuel lanes, including at least one fuel lane 59. Each fuel lane participating in the fuel authorization program includes an IR data link component 60 (i.e., an IR receiver) disposed proximate to a fuel dispenser 62, and a vehicle detecting sensor 64, each of which is logically coupled to controller 56. Note that controller 56 and RF component 58 of refueling facility 54 are intended to support a plurality of different fuel lanes participating in the fuel authorization program. As discussed below, the concepts disclosed herein also encompass embodiments where each participating fuel lane includes its own RF component and processor component.

To recap the functions implemented by the various components in the enrolled vehicle and the refueling facility in the exemplary fuel authorization method of FIG. 2B, as the enrolled vehicle enters a fuel lane participating in the fuel authorization program, sensor 64 detects the vehicle, and processor 56 uses RF component 58 to send an RF query to the vehicle. The RF query is received by RF component 46 in an enrolled vehicle, and vehicle controller 42 responds by causing IR component 44 to transmit an IR response to IR component 60. An RF data link between the enrolled vehicle and the fuel vendor is thus established using RF components 46 and 58. ID data (such as a VIN) uniquely identifying the vehicle is acquired from memory 48 and conveyed to controller 56 using one or both of the IR and RF data links In some embodiments, passwords or encryption keys are also stored in memory 48 and are used to confirm that the vehicle is enrolled in the fuel authorization program. Once the enrolled vehicle's status in the fuel authorization program is confirmed, controller 56 enables operation of fuel dispenser 62 (so long as sensor 64 indicates that the enrolled vehicle has not exited the fuel lane). It should be noted that if controller 56 and RF component 58 are used to support a plurality of different fuel islands participating in the fuel authorization program, then RF component 58 will need to have sufficient range, power, and bandwidth to support simultaneous operations with a plurality of fuel islands.

The function of optional lights 47 and 49 will now be discussed. IR data from IR component 44 is highly directional, and successful IR data transmission requires alignment between IR component 44 in the vehicle and IR component 60 in the fuel lane. A first light 47 is used to indicate to the driver of the vehicle that an IR data link has been established. A second light 49 is used to indicate to the driver of the vehicle that the IR data transmission is complete, such that if the vehicle needs to be moved relative to the fuel dispenser to enable the fuel dispenser to reach the vehicle's fuel tanks, the movement can be implemented without interrupting the IR data transmission. It should be recognized that other techniques (such as the use of a visual display, or audible prompts via output device 52) could similarly be used to convey corresponding information to the vehicle operator. Note that in embodiments employing such indicator lights, the IR data link need not be active during the refueling operation (i.e., the IR data link need only be operational long enough to establish the RF data link between the fuel vendor and the vehicle). In other embodiments, the RF data link is operational during refueling, to ensure that the vehicle remain at the fuel island during refueling, so no fuel can be diverted to an unauthorized vehicle.

As noted above, in at least some embodiments, controller 42 also uses the RF data link between the vehicle and the refueling facility to transfer data other than that needed to verify that the enrolled vehicle is authorized to participate in the fuel authorization program. This additional data can include without any implied limitation: fault code data, vehicle performance and/or fuel efficiency and consumption_data, and driver data (such as driver ID and the driver's accumulated hours for compliance and payroll). A potentially useful type of additional data will be fuel use data collected by components 50. FIG. 5 is a functional block diagram showing some exemplary components used to collect fuel use data, including a fuel tank level sensor 50a (indicating how much fuel is stored in the vehicle's fuel tanks before refueling), fuel injectors sensors 50b (configured to determine how much fuel has passed through the engine fuel injectors, indicating how much fuel has been consumed by the vehicle), an engine hour meter 50c (configured to determine how many hours the vehicle's engine has been operated, which can be used in addition to or in place of the fuel injector data to determine how much fuel the vehicle has consumed), and an odometer 50d (configured to determine how many miles or kilometers the vehicle has traveled, which can be used in addition to or in place of the fuel injector data (or engine hour data) to determine how much fuel the vehicle has consumed).

FIG. 6 is a logic diagram showing exemplary method steps implemented in at least some of the vehicle refueling programs disclosed herein, where fuel use data transferred from the vehicle are used to determine if possible fraud has occurred. In a block 30, fuel use data are collected from an enrolled vehicle via the RF data link between the vehicle and the refueling facility (this data could be transmitted via the IR data link; however, IR data transmission is much slower, and the vehicle may have been repositioned, breaking the IR data link, for example, to enable the fuel dispenser nozzle to better reach the authorized vehicle's fuel tanks) In a block 32, the fuel use data are compared with historical fuel purchases. A decision block 34 determines if more fuel was purchased than used. If not, then the method terminates in a block 38. However, if the data indicate more fuel was purchased than can be accounted for based on the fuel consumption data (which can include the amount of fuel in the vehicle's tanks), then an alert is issued in a block 36 to indicate that some type of fuel fraud may have occurred. In at least some embodiments, the analysis of FIG. 6 is performed in real-time, during refueling (or before the fuel dispenser is enabled), and the alert can include the function of disabling the fuel dispenser. In other embodiments, the analysis of FIG. 6 is performed after refueling is completed, and the alert can include notifying the owner of the vehicle (exemplary but not limiting notifications include instant message notifications and email notifications).

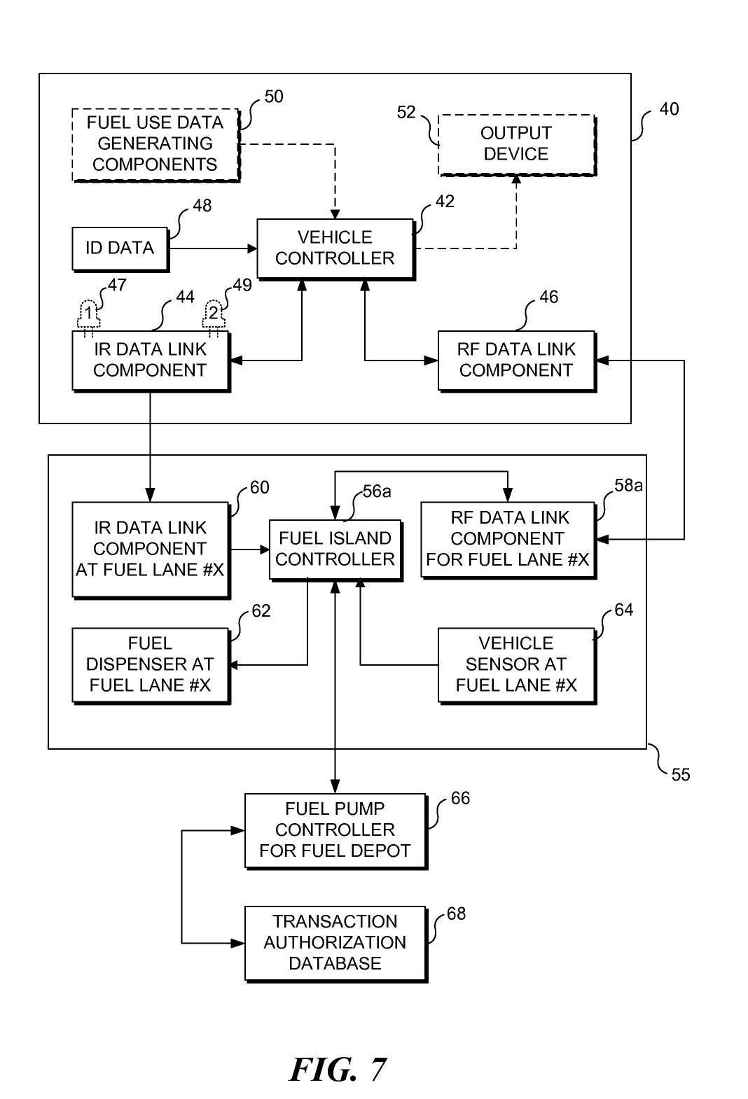

FIG. 7 is another exemplary functional block diagram showing the basic functional components used to implement the method steps of FIG. 2B, wherein most of the components used by the fuel vendor to implement the method are disposed proximate each individual fuel dispenser. Note that FIG. 7 is closely related to FIG. 4; however, in this embodiment, each fuel island has its own processor and RF component (i.e., those components are not shared across multiple fuel islands/fuel lanes), which enables a relatively lower power, shorter range RF component to be used by each fuel island, thereby reducing crosstalk and the potential of signal confusion.

Vehicle 40 in FIG. 7 remains unchanged from FIG. 4. Rather than illustrating a refueling facility 54 including a plurality of fuel islands, FIG. 7 shows a single fuel island 55, which includes each of the following elements: a fuel island controller 56a, a short range RF component 58a, sensor 64, fuel dispenser 62, and IR component 60. In this embodiment, the refueling facility/fuel vendor employs a fuel pump controller 66 to manage the enabling of each fuel dispenser at each fuel island in accord with the fuel authorization concepts discussed herein. Many refueling facilities are configured at least in part, in a similar manner, since point of sale devices such as credit card scanners are disposed at each fuel island, and such scanners are logically coupled to the fuel pump controller that interacts with each fuel dispenser. Once the sale is approved, the fuel pump controller enables the fuel dispenser for the appropriate fuel lane. In this embodiment, the fuel island controller is logically coupled to fuel pump controller 66, which itself is logically coupled to a transaction authorization database 68 (which may be located at the refueling facility or at a remote location). Fuel pump controller 66 queries the information in transaction database 68 to make sure that the enrolled vehicle (which has established that it is enrolled in the fuel authorization program based on the RF communication with fuel island controller 56a) is still authorized to receive fuel (the owner of the vehicle may be behind in payments, or the driver of that vehicle may be suspected of fuel fraud, causing the refueling authorization for that vehicle to be revoked, much like a credit card might be declined for a bad credit risk).

FIG. 8 schematically illustrates vehicle components and fuel island components used to implement the method steps of FIG. 2B. A fuel island participating in the fuel authorization program may include a canopy 90 (or other support) to which a motion detector 88 is coupled, as well as a fuel pump 75 (the fuel dispenser) upon which an IR receiver 86 is disposed. Not specifically shown are the RF component and the processor. It should be recognized that the canopy is not required, and the motion sensor could be disposed in a different location, so long as vehicle motion proximate the fuel dispenser can be detected. As enrolled vehicle 74 enters the fuel lane, motion detector 88 detects the vehicle. The RF query is initiated as discussed above, and an IR transmitter 84 on the vehicle conveys IR data to IR receiver 86 (note that transmitter 84 and receiver 86 are generally aligned when the cab of the vehicle is aligned with the fuel dispenser). As shown in FIG. 8, the IR receiver is located on the fuel pump. It should be recognized that such a location is exemplary, and not limiting. In at least one additional exemplary embodiment, where the fuel island includes a canopy, the IR receiver is attached to the canopy. In a particularly preferred, but not limiting embodiment, each fuel authorization element disposed at the fuel island is contained in a common housing attached to the canopy (in at least one exemplary embodiment, this common housing contains the motion sensor, the IR receiver, the RF component, and the fuel island processor). Note that in embodiments in which the IR receiver is mounted on the canopy, the IR transmitter in the vehicle can direct the IR beam upwardly through the windshield of the vehicle. This configuration minimizes IR signal noise, as ambient light (such as reflected sunlight) is less likely to be received by the IR receiver. With respect to facilitating an alignment between the IR transmitter and the IR receiver, various techniques, including the lights discussed above, can be used to help the driver make sure the IR receiver and IR transmitter are aligned. In one embodiment, paint stripes in the fuel island can provide visual references to the driver, so the driver can ensure that the IR receiver and IR transmitter are aligned. As noted above, in at least one exemplary embodiment, the IR transmitter is placed proximate the windshield of the vehicle so the IR beam can pass through the windshield glass. If the fuel island includes a dedicated RF component and processor, those elements can be placed in many different alternative locations on the fuel island. As noted above, in at least one exemplary embodiment, such elements are placed in a common housing, along with motion detector 88.

Some types of motion detectors function by sending out an ultrasonic pulse, and receiving a reflected pulse, to determine a distance between the sensor and the reflective surface. In FIG. 8, a distance 85 represents a distance that will be detected by the sensor when no vehicle is present and the signal from the sensor is being reflected by the ground under the canopy. A distance 87 represents a distance that will be detected by the sensor when a vehicle is present and the signal from the sensor is being reflected by the cab of the vehicle. A distance 89 represents a distance that will be detected by the sensor when a vehicle is present and the signal from the sensor is being reflected by a cargo storage area of the vehicle, where that portion of the vehicle is relatively taller than the cab. The sensor will generally be able to distinguish between distances 85, 87, and 89. In various embodiments, the fuel island processor can use data from the motion sensor to control the fuel authorization process. In one exemplary embodiment, the fuel island controller is configured to ignore fuel authorization requests if the motion sensor reports a distance that does not meet a predefined minimum (this would prevent fuel authorizations for smaller vehicles, such as cars, that might have been equipped with components to attempt to spoof the fuel authorization system). In another exemplary embodiment, the fuel island controller is configured to keep the pump enabled so long as the motion sensor reports a distance that ranges between a predefined minimum and a predefined maximum, which generally correspond with the dimensions of vehicles enrolled in the fuel authorization program (such as commercial trucks, including ut not limited to tractor/trailer combinations). This enables drivers to move their vehicle relative to the fuel island after the IR data link has been established, to make sure the vehicle's fuel tanks are properly positioned relative to the fuel dispenser (which may not always be the case when the IR receiver and transmitter are aligned, depending on the relative position of the vehicle's fuel tanks).

In another exemplary embodiment, the vehicle is a tractor trailer combination, and the tractor has a first fuel tank generally located proximate the cab of the tractor, and the trailer has a second fuel tank generally located proximate the rear or midpoint of the trailer, and the tractor and the trailer have different heights. The second fuel tank is for fuel used by a refrigeration unit for the trailer. Significantly, fuel used in the first fuel tank for the tractor is taxed at a different rate than fuel used by the trailer for refrigeration. The fuel island processor can be configured to use data from the motion sensor to determine whether the vehicle is positioned to receive fuel in the first or second fuel tank, so that the fueling data collected by the fuel vendor can account for the tax differential. In at least one embodiment, the fuel island processor is configured to assume that fuel delivered initially is received by the first fuel tank (i.e., fuel for the tractor), and that if the motion sensor detects a change in distances (i.e., such as the difference between distances 87 and 89), that subsequently delivered fuel (i.e., fuel delivered after the height/distance change) is fuel for the refrigeration unit. In an exemplary embodiment, distance 85 is generally about 200 inches, and the fuel island controller is configured to assume that any reading between about 174 inches and about 200 inches indicates that the fuel lane is empty. Reefers (refrigerated trailers) generally are about 162 inches or taller. Non-refrigerated trailers and tractor cabs are generally less than about 162 inches in height. Based on those distances, in a related exemplary embodiment the fuel island controller (or a non-local controller analyzing data from the range finder/motion sensor at the fuel island) is configured to assume that when distance 89 ranges from about 0 to less than about 38 inches, that a reefer trailer is underneath the sensor (the sensor is 200 inches from the ground, and a reefer trailer is greater than about 162 inches in height). Similarly, the fuel island controller is configured to assume that when distance 89 (or distance 87) ranges from about 39 inches to about 173 inches a non-reefer trailer or cab (or some other type of vehicle) is underneath the sensor. Thus, the processor can be configured to determine when a reefer trailer is positioned beneath the sensor. The controller can then be configured to assume that fuel delivered when a reefer trailer is positioned below the sensor is fuel to be used for the reefer trailer, and not for the power unit (i.e., for the tractor pulling the trailer). In at least one embodiment, the fuel island controller is configured to apportion fuel as follows. When the distance between the sensor ranges from about 39 inches to about 173 inches, and fuel delivery is enabled, that fuel is allocated to over the road use. If the sensor detects that the vehicle being fueled is repositioned, and the distance between the sensor and the vehicle now ranges from about 0 inches to less than about 38 inches (i.e., the sensor detects that the distance between the sensor and the vehicle has decreased), then any fuel delivered subsequently is assumed to be fuel for a reefer trailer, and not for over the road use (thus, the second portion of fuel can be taxed at a different rate). The decrease in distance between the sensor and the vehicle is because the fuel tanks for the over the road use are part of the power unit (i.e., the tractor), while the fuel tanks for a reefer are near a midpoint or rear of the reefer trailer, thus the vehicle needs to be moved to allow the fuel dispenser to reach the reefer fuel tanks

In one or more of the embodiments disclosed herein, the fuel island processor (whether actually located at the fuel island or elsewhere) can be configured so that the fuel dispenser is disabled whenever the sensor detects distance 85, indicating that the vehicle has exited the fuel lane.

FIG. 9 is a logic diagram showing exemplary overall method steps implemented in a third exemplary embodiment for implementing a vehicle refueling program in accord with the concepts disclosed herein, the third exemplary embodiment being closely related to the method steps of FIG. 2B. The modifications to the method of FIG. 9 are based on using specific detection technology (i.e., motion sensors), including a short range RF component on each fuel island participating in the fuel authorization program, as well as specific data exchanged between the fuel island and enrolled vehicle. In a block 10a, a motion sensor at the fuel island detects the presence of a vehicle. In a block 12a, the fuel island processor uses the fuel island RF component to send a low power short range RF query to the vehicle. If the detected vehicle is enrolled in the fuel authorization program, then in a block 14a, the vehicle uses IR to transmit its VIN to the IR receiver at the fuel island. This VIN transmission provides initial identification data that could be used by the fuel island processor to determine if the responding vehicle is participating in the fuel authorization program (or the verification can be performed later, as discussed below). In a block 16a, an encrypted RF data link is established between the fuel island and the vehicle. The encryption is employed as a mechanism to ensure that the vehicle is properly enrolled in the fuel authorization program, while safeguarding the data interchange between the vehicle and the fuel island. Encryption keys can be changed periodically, and vehicles that do not have current keys will not be able to participate in the fuel authorization program, thereby preventing previously enrolled vehicles who are not currently participating in the program from using their fuel authorization components to acquire fuel (and preventing stolen components from being used by non-authorized vehicles). Referring back to block 14a, in at least some embodiments, providing the vehicle VIN over the IR data link enables the fuel island processor to select unique encryption keys assigned to a particular vehicle or fleet owner. If an encrypted RF data link cannot be established, then the vehicle's authorization for receiving fuel will be denied (and some other mechanism will need to be used by the driver to pay for fuel). Note that block 16a combines elements from blocks 16 and 18 in FIG. 2B. Referring once again to FIG. 9, assuming the encrypted data link has been established, in a block 20a, the fuel island processor sends data about the enrolled vehicle to a fuel pump controller (generally as discussed above in connection with FIG. 7), which queries a transaction database to determine if the fuel dispenser at the fuel island should be enabled, in a block 21.

In the exemplary embodiment of FIG. 9, the vehicle's IR transmitter is not energized until the vehicle receives an RF query from the fuel vendor (in response to the detection of the vehicle at a fuel island). This will reduce the power drain caused by the RF transmitter, and will prolong the service life of the IR light source.

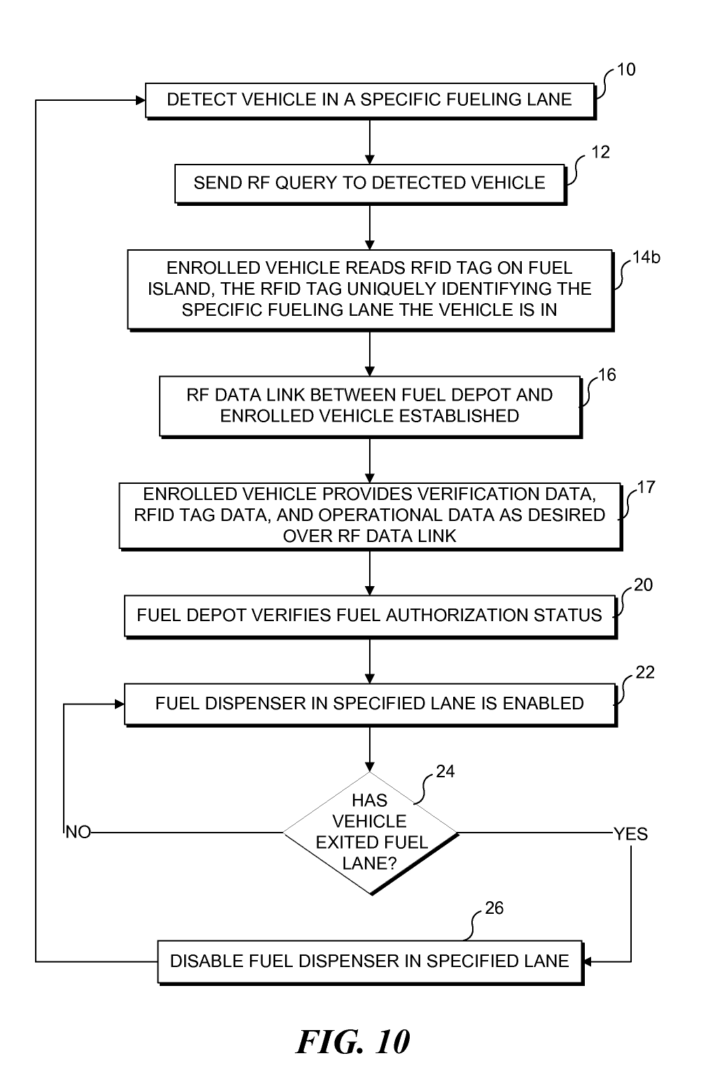

FIG. 10 is a logic diagram showing exemplary method steps implemented in a fourth exemplary embodiment for implementing a fuel authorization method in accord with the concepts disclosed herein. In this embodiment, instead of using an IR transmission between the vehicle and a fuel island to verify to which fuel island the vehicle is proximate, an interaction between an RFID tag on the fuel dispenser (or some other location on the fuel island) and an RFID tag reader on the vehicle is employed. Steps that have not changed relative to the exemplary steps of FIG. 2A/2B maintain common reference numbering. Referring to FIG. 10, in block 10, a vehicle is detected moving into an empty fuel lane, and in block 12 an RF query is generated to interrogate the detected vehicle. In a block 14b, an RFID tag reader on the vehicle reads an RFID tag on the fuel island. In an exemplary but not limiting implementation, the RFID tag is on the fuel pump/fuel dispenser, and the RFID tag reader is on the driver door of the vehicle, so that the driver merely needs to align the door of the vehicle with the fuel pump to ensure that the reader can read the RFID tag. The RFID tag includes data specifically identifying the fuel island. In block 16, an RF data link between the fuel vendor and the detected vehicle is established, to facilitate further verification, as well as to enable the vehicle to convey any operational and additional data, as desired. In a block 17, the vehicle uses the RF data link to convey verification data to the fuel vendor, along with any additional data that is desired, including the fuel island identification data read from the RFID tag at the fuel island, ensuring that the fuel vendor will unambiguously recognize which of a plurality of fuel islands should be enabled to refuel the vehicle. In block 20, the fuel vendor verifies that the vehicle is authorized to participate in the fuel authorization program. Once the authorization is approved, the fuel dispenser to which the vehicle is adjacent is enabled in block 22, and the enrolled vehicle is enabled to be refueled. After the fuel dispenser has been enabled, the sensor in the fuel lane is monitored to determine if the enrolled vehicle moves out of the fuel lane, as indicated in decision block 24. If no motion (or no more than a predefined amount of motion) is detected, then the logic loops back to block 22 and the fuel dispenser remains enabled. If motion (or more than the predefined amount of motion) is detected, then in block 26, the fuel dispenser is disabled, and the process is repeated when another vehicle is detected entering the fuel lane. Significantly, the method of FIG. 10 requires that the response from the vehicle to the RF query be an RF-based response, which includes data read from the RFID tag at the fuel island.

If desired, the method of FIG. 10 can be modified such that the fuel island does not need to include a sensor to detect the vehicle. In the modified method, steps 10 and 12 are eliminated, and the vehicle simply reads the RFID tag at the fuel island. The RFID tag reading step can be initiated using several different techniques. In one exemplary embodiment, the RFID tag reader can be activated via a user input, so that the driver simply activates the RFID tag reader when he positions the vehicle in a fuel lane that is participating in the fuel authorization program (the unit can include an auto-shutoff feature that will turn the unit off after a predetermined period of time, so that if the driver does not turn the unit off there is no long term power drain). In another exemplary embodiment, the RFID tag reader is enabled when it is determined that a position of the vehicle generally corresponds with a position of a participating fuel vendor. A position sensing system, such as a GPS receiver, can be used to perform this position matching function. In this embodiment, the RFID tag reader is enabled as a vehicle approaches a participating fuel vendor. The fuel vendor may have a plurality of participating fuel lanes, each with a different tag. The use of RFID tags and RFID tag readers of limited range (i.e., less than about a yard) will prevent the vehicle's RFID tag reader from reading RFID tags in different fuel lanes. As will be discussed below, a telematics unit in the vehicle can be used to collect data indicative of the vehicle moving away from the fuel dispenser, and that data can be conveyed to the fuel vendor so the fuel dispenser can be disabled at that point, so the motion sensor is not required to implement that function.

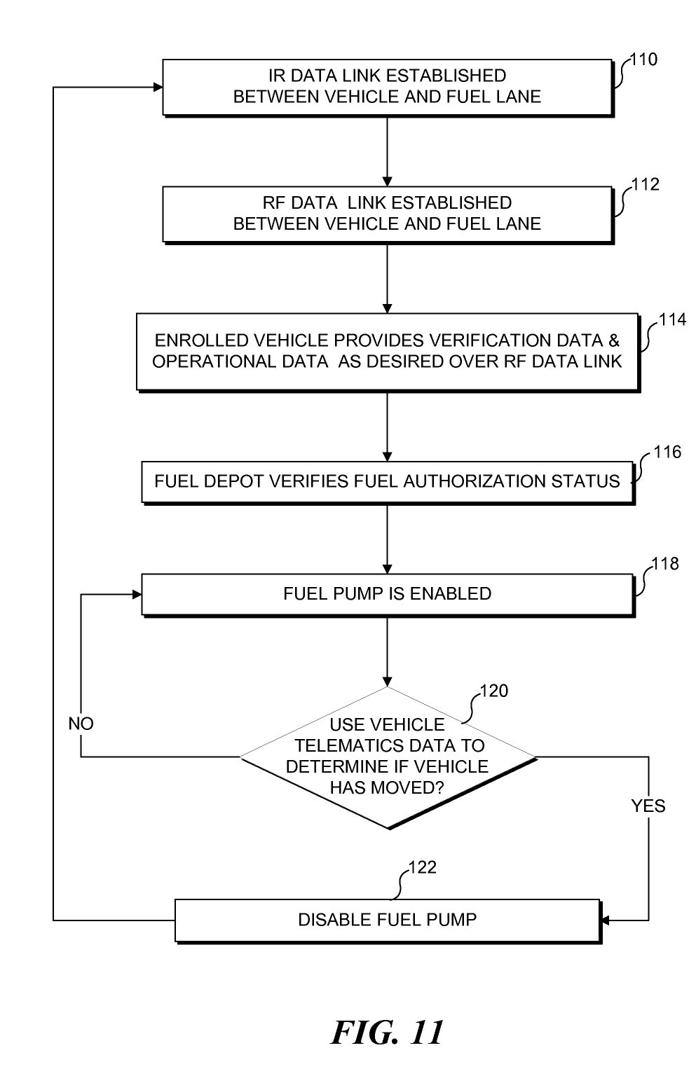

FIG. 11 is a logic diagram showing exemplary overall method steps implemented in a fifth exemplary embodiment for implementing a fuel authorization method in accord with the concepts disclosed herein. This fifth embodiment is very closely related to the embodiment of FIG. 9, however, modifications eliminate the need for each participating fuel island to include a vehicle sensor. This embodiment once again is based on using an interaction between an IR transmitter and IR receiver, one at the fuel island and the other on the vehicle. In this embodiment, the vehicle includes a telematics unit that can be used in place of the motion sensor at the fuel island to determine if the vehicle moves away from the fuel island after the fuel dispenser is enabled, so that the fuel dispenser can then be disabled to prevent fuel from being dispensed to a different, non-authorized vehicle.

Referring to FIG. 11, in a block 110, after a vehicle enters a fuel lane, an IR data link is established between the vehicle and fuel island, generally as discussed above. In a block 112, the telematics unit (which includes or is logically coupled to an RF data link component) establishes an RF data link with the fuel vendor. In some embodiments, the RF data link is established with a fuel vendor RF unit at the fuel island, while in other embodiments, the RF data link is established with a fuel vendor RF data link component supporting a plurality of different fuel islands, generally as discussed above. This RF data link is used to enable the vehicle to convey data required to verify that the vehicle is enrolled in the fuel authorization program (i.e., data such as a VIN that can be used to identify the vehicle), as indicated in a block 116. In some embodiments, the RF data link established is encrypted, such that the vehicle's use of a current encryption key (or password) provides an additional level of security, indicating that the vehicle is indeed authorized to participate in the fuel authorization program. The RF data link can also be used to convey any operational and/or additional data desired, generally as discussed above. In a block 118, the fuel vendor verifies that the vehicle is authorized to participate in the fuel authorization program. Once the authorization is approved, the fuel dispenser identified by the RFID tag data is enabled in a block 120, and the enrolled vehicle can be refueled. After the fuel dispenser has been enabled, data from the telematics unit in the vehicle, conveyed in real-time, are monitored by a fuel vendor controller (either a dedicated controller located at the specific fuel island, or a fuel vendor controller simultaneously supporting other fuel islands, generally as discussed above) to determine if the authorized vehicle remains at the enabled fuel island, as indicated in decision block 122. If the telematics data indicates that the vehicle has not moved away from the fuel island, then the logic loops back to block 120 and the fuel dispenser remains enabled. If the telematics data indicates that the vehicle has moved away from the fuel island, then in a block 124 the fuel dispenser is disabled, and the process is repeated when an IR data link is established with another enrolled vehicle.

With respect to the data provided by the vehicle's telematics unit in decision block 122, it should be recognized that many types of data that can be collected by a vehicle telematics unit can be employed, including but not limited to geographical coordinate data (from a GPS or equivalent system), data from the vehicle indicating that a parking brake has been released, data from the vehicle indicating that the vehicle's engine has been started, and data from the vehicle indicating that the vehicle's transmission has been placed into gear. Certain types of telematics data may be sufficient to enable allowing a predefined amount of movement to occur before disabling the fuel delivery, so the vehicle can be slightly repositioned if required to place the vehicle's fuel tanks sufficiently close to the fuel dispenser to enable refueling.

Referring once again to block 110, several different techniques can be used to initiate the IR data link. In one exemplary embodiment, the IR transmitter in the vehicle can be activated via a user input, so that the driver simply activates the IR transmitter when he positions the vehicle in a fuel lane that is participating in the fuel authorization program (the unit can include an auto-shutoff feature that will turn the unit off after a predetermined period of time, so that if the driver does not turn the unit off there is no long term power drain). In another exemplary embodiment, the IR transmitter is enabled when it is determined that a position of the vehicle generally corresponds with a position of a participating fuel vendor. A position sensing system, such as a GPS receiver, can be used to perform this position matching function. In this embodiment, the IR transmitter is enabled as a vehicle approaches a participating fuel vendor. The fuel vendor may have a plurality of participating fuel lanes, each with a different IR receiver; however, the IR receivers will be positioned such that a vehicle must be in the fuel lane for that fuel lane's IR receiver to participate in an IR data link with the vehicle. In some cases, the vehicle may be arriving near the fuel vendor's location without the intention to refuel. To prevent the IR transmitter from being energized for an extended period of time under such circumstances, the IR transmitter can be configured to energize only when the location of the vehicle generally corresponds to the location of the fuel vendor, and the vehicle is turned off (thus the IR transmitter will not be energized if the vehicle is waiting in line, or idling near the fuel vendor's facility). The IR transmitter can be configured to remain energized for a predetermined period of time, such that if the vehicle has parked near the fuel vendor's location, and been turned off, but no refueling is to occur, the IR transmitter will only be energized for a limited amount of time.

In at least one additional exemplary embodiment, the IR data link in the embodiment of FIG. 11 is replaced by an RFID tag/reader interaction between the truck and the fuel island. In such an embodiment, only short range RFID tags should be employed, to prevent enrolled vehicles from reading RFID tags in different fuel lanes.

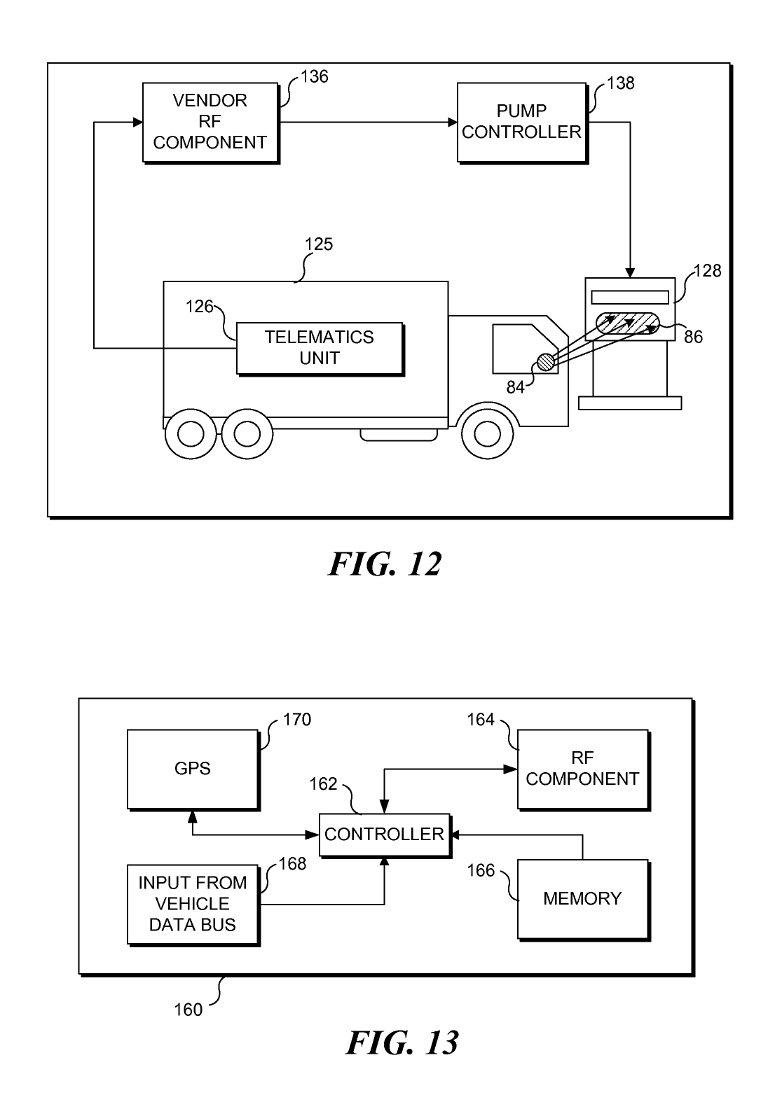

FIG. 12 schematically illustrates vehicle components and fuel island components used to implement the method steps of FIG. 11. A vehicle 126 (equipped with a telematics unit 125 including (or coupled with) a component configured to establish an RF data link with the fuel vendor) enters a fuel lane including fuel dispenser 128. An IR data link is established between IR transmitter 84 (in the vehicle) and IR receiver 86 on the fuel island (noting that the IR receiver at the fuel island in some exemplary embodiments will be attached to a canopy, to minimize an amount of IR noise received by the IR receiver). After the IR data link is used to enable the fuel vendor controller to unambiguously determine at which fuel dispenser the enrolled vehicle will be using to refuel, telematics unit 126 establishes the RF data link with a fuel vendor RF component 136. The telematics unit uses the RF data link (which if desired, may be encrypted to provide greater assurance that vehicle 126 is an authorized participant in the fuel authorization program to better protect the authorization process) to convey the required fuel authorization verification data, and any additional vehicle data desired to the fuel vendor. A fuel vendor controller 138 uses such data to determine if fuel delivery is authorized, and if so, enables fuel dispenser 128.

FIG. 13 is a functional block diagram of an exemplary telematics device added to an enrolled vehicle to implement some of the method steps of FIG. 11. An exemplary telematics unit 160 includes a controller 162, a wireless data link component 164, a memory 166 in which data and machine instructions used by controller 162 are stored (again, it will be understood that a hardware rather than software-based controller can be implemented, if desired), a position sensing component 170 (such as a GPS receiver), and a data input component 168 configured to extract vehicle data from the vehicle's data bus and/or the vehicle's onboard controller. Other telematics devices can be employed, so long as the telematics device can acquire the RFID tag data identifying the fuel island from the handheld device and convey that RFID tag data to the fuel vendor's RF component.

The benefit of the telematics unit based embodiments of FIGS. 11-13 is that more and more fleet vehicles employ telematics units with wireless data transfer capability, so that many of the components used for this embodiment have already received market acceptance. An additional benefit is that the capital investment by the fuel vendor is reduced, by eliminating the need for the motion sensor.

Referring to FIG. 13, telematics unit 160 has capabilities exceeding those required for participating in a fuel authorization program. The additional capabilities of telematics unit 160 are particularly useful to fleet operators. Telematics unit 160 is configured to collect position data from the vehicle (to enable vehicle owners to track the current location of their vehicles, and where they have been) and to collect vehicle operational data (including but not limited to engine temperature, coolant temperature, engine speed, vehicle speed, brake use, idle time, and fault codes), and to use the RF component to wirelessly convey such data to vehicle owners. These data transmission can occur at regular intervals, in response to a request for data, or in real-time, or be initiated based on parameters related to the vehicle's speed and/or change in location. The term “real-time” as used herein is not intended to imply the data are transmitted instantaneously, since the data may instead be collected over a relatively short period of time (e.g., over a period of seconds or minutes), and transmitted to the remote computing device on an ongoing or intermittent basis, as opposed to storing the data at the vehicle for an extended period of time (hour or days), and transmitting an extended data set to the remote computing device after the data set has been collected. Data collected by telematics unit 160 can be conveyed to the vehicle owner using RF component 164.

In at least one embodiment, encryption keys or passwords required by the fuel authorization program are stored in memory 166, and are accessed during one or more of the fuel authorization methods discussed above. To prevent parties from stealing telematics unit 160 and installing the unit on a non-authorized vehicle and attempting to use the stolen telematics unit to acquire fuel from the fuel authorization program, in at least one exemplary embodiment, the passwords/encryption keys required for authorized refueling are changed from time-to-time. Thus, the stolen telematics unit can only be used to access the fuel authorization program for a limited time. Note that an even more secure system can be achieved by storing the encryption keys or passwords not in memory 66, but in some other memory that is not easily removed from the vehicle, such that moving telematics unit 160 from the enrolled vehicle to a non-authorized vehicle will not enable the non-authorized vehicle to participate in the fuel authorization program, because the required passwords/encryption keys are not available in the non-authorized vehicle. In at least one further embodiment, the telematics unit is configured to acquire the VIN or other ID number needed to participate in the fuel authorization program from a memory in the vehicle that is not part of the telematics unit. In such an embodiment, if a telematics unit is stolen and installed on a vehicle not enrolled in the fuel authorization program, when the stolen telematics unit acquires the new vehicle's VIN as part of the fuel authorization methods discussed above, that vehicle would not be allowed to refuel under the authorization program, because the new vehicle's VIN would not be recognized as corresponding to an enrolled vehicle. In at least one embodiment, each telematics unit has a unique serial number, and the fuel authorization program can check the vehicle ID number and the telematics ID number to determine if they are matched in the database before enabling fuel to be acquired under the fuel authorization program, to prevent stolen telematics units, or telematics units moved without authorization, to be used to acquire fuel.

In a similar embodiment, telematics unit 160 is configured to receive updated passwords/encryption keys via RF component 164, but such passwords/keys are not stored in the telematics unit (or a separate memory in the vehicle) unless the telematics unit acquires a VIN or ID number (from a memory on the vehicle that is not part of the telematics unit) that matches an ID conveyed along with the updated encryption key/password. This approach prevents stolen telematics units from acquiring updated passwords or encryption keys.

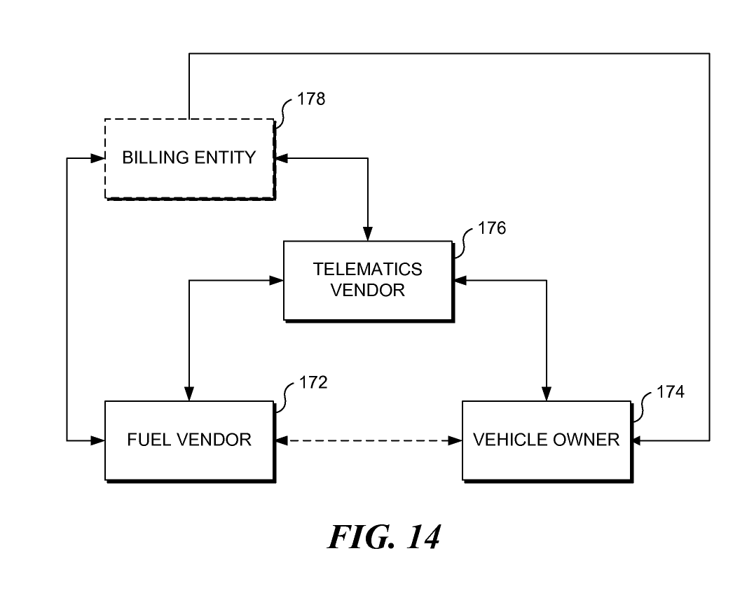

FIG. 14 is a functional block diagram illustrating how data collected in the fuel authorization management methods disclosed herein can be shared among various parties. FIG. 14 identifies three primary parties and an optional party. The primary parties include a fuel vendor 172 (which may manage more than one fueling station), a vehicle owner 174 that has one or more vehicles enrolled in the fuel authorization program (although the vehicle owner can be an individual, it will most often be a company operating a fleet of vehicles), and a telematics vendor 176. The telematics vendor may only provide services related to the fuel authorization program, but will likely offer other services as well, which are directed to vehicle operators/owners. An optional party is a billing entity 178.

As shown in FIG. 14, fuel vendor 172 communicates data collected from vehicles participating in the fuel authorization program with telematics vendor 176. The data collected can be limited to data relevant to the fuel authorization program (exemplary data can include the amount of fuel delivered, the identity of the vehicle refueled, the time and data of refueling, and the location of the refueling facility). In at least some embodiments, other data from the vehicle is collected by the fuel vendor, and that other data (which can include, but are not limited to, inspection data (collected with or without a handheld device as discussed above), driver hour data for legal compliance, driver data for payroll purposes, and vehicle operational data (including but not limited to fault codes)) can be relayed to the telematics vendor and/or the vehicle owner from the fuel vendor (exemplary data transmission techniques include wireless data transmission, land line transmission, and/or transmission over a data network, such as the Internet, and/or a public or private local or wide area network). The telematics vendor and fuel vendor can exchange and share current passwords and encryption keys. The telematics vendor can also communicate wirelessly with each enrolled vehicle (via the RF component in the telematics unit of FIG. 13 provided by the telematics vendor) to ensure the enrolled vehicles have current passwords/encryption keys. The telematics vendor and the vehicle owner can communicate to enable the vehicle owner to acquire telematics data about its vehicles that are conveyed from the vehicles to the telematics vendor. In at least one exemplary embodiment, the telematics vendor hosts a password controlled website that can be accessed by vehicle owners (such as fleet operators) to review data collected by the telematics units installed on their vehicles. Whenever a vehicle owner makes changes to its vehicles, such as moving a telematics unit from a vehicle being retired from service to a new vehicle, that information is conveyed to the telematics vendor and fuel vendor, so that the new vehicle or moved telematics unit is recognized in the fuel authorization program. In some embodiments, the fuel vendor employs billing entity 178 to bill the vehicle owner for fuel acquired in the fuel authorization program. If desired, the billing entity can also convey the fuel authorization program data to telematics vendor 176.

At least some of the concepts discussed above generally address two significant concerns. First, the fuel vendor needs to unambiguously know what fuel dispenser should be enabled for which participating vehicle. The use of RF data transmission alone between the fuel vendor and the participating vehicle is not optimal, because RF transmissions can be reflected, and it is potentially possible that relying on RF transmissions alone could result in the fuel vendor enabling a first fuel dispenser when the participating vehicle is actually proximate a second fuel dispenser. Some of the concepts discussed herein address this issue by using an IR interaction between the vehicle and a specific fuel lane, so that enablement of the appropriate fuel dispenser is more certain. Other ones of the concepts discussed herein address this issue by using a very short range RFID tag/reader interaction between the vehicle and a specific fuel lane, so that enablement of the appropriate fuel dispenser is more certain (the vehicle includes a reader that acquires data from an RFID tag at the fuel island, and that tag data is conveyed to the fuel vendor so the fuel vendor knows which pump to enable).

A second concern is preventing non-authorized vehicles from participating in the fuel authorization program by removing a relatively easy to remove component from an enrolled vehicle, and temporarily (or permanently) installing that component on the non-authorized vehicle. Some of the concepts discussed herein address this issue by requiring the vehicle that wishes to acquire fuel to include one or more components needed for the authorization process, but such components do not themselves store all the data required for authorization. Instead, such components are configured to acquire the data (in response to a fuel vendor request for the data) from a memory in the vehicle that is not readily removable, thus deterring drivers from temporarily removing a required authorization component and loaning it to another vehicle. Other ones of the concepts discussed herein address this issue by using passwords and/or encryption keys that are regularly updated, so that a stolen vehicle component required to participate in the fuel authorization program will only be useful for a limited period of time (i.e., until the password/encryption key is changed).

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

1. A method for administering a fuel authorization program, the method comprising the steps of:
(a) using an infrared (IR) data link between a fuel vendor and a vehicle to identify a fuel lane from which the vehicle is to acquire fuel, wherein a nature of the IR data link is such that the IR data link cannot be readily established unless the vehicle is physically present in the identified fuel lane;
(b) using a radiofrequency (RF) data link between the fuel vendor and the vehicle to verify that the vehicle is enrolled in the fuel authorization program; and
(c) after determining the vehicle is enrolled in the fuel authorization program and is authorized to receive fuel, enabling fuel delivery at the identified fuel lane, so long as the vehicle remains in the specific fuel lane.

2. The method of claim 1, further comprising the steps of:
(a) detecting the presence of a vehicle in the fuel lane;
(b) transmitting a wireless query from the fuel vendor to the vehicle in response to detecting the presence of the vehicle; and
(c) establishing the IR data link between the fuel vendor and the vehicle in response to the wireless query from the fuel vendor.

3. The method of claim 2, wherein the step of detecting the presence of the vehicle in the fuel lane comprises the step of using a range finder to detect the vehicle in the fuel lane.

4. The method of claim 1, further comprising the step of establishing the IR data link between the fuel vendor and the vehicle in response to determining that a location of the vehicle generally corresponds with a location of the fuel lane.

5. The method of claim 1, wherein the step of using the RF data link between the fuel vendor and the vehicle to verify that the vehicle is enrolled in the fuel authorization program comprises the step of establishing an encrypted RF data link between the fuel vendor and the vehicle.

6. The method of claim 1, wherein the step of establishing the encrypted RF data link comprises the steps of:
(a) attempting to decrypt an RF communication from the vehicle using a current decryption key; and
(b) if decryption using the current decryption key fails, attempting to decrypt the RF communication from the vehicle using older versions of the decryption key, a number of older versions of the decryption key for which decryption attempts will be made being predefined.

7. The method of claim 1, wherein the step of using the RF data link between the fuel vendor and the vehicle to verify that the vehicle is enrolled in the fuel authorization program comprises the step of acquiring verification data from a non-transitory memory in the vehicle that is not readily removable, such that receipt of the verification data by the fuel vendor indicates that the vehicle in the identified fuel lane is enrolled in the fuel authorization program, rather than being a non-authorized vehicle attempting to masquerade as an enrolled vehicle by using an authorization component that is easily removed from an enrolled vehicle.

8. The method of claim 1, wherein after the step of the step of enabling fuel delivery at the identified fuel lane, using a sensor to determine if the vehicle has exited the fuel lane, and if so, disabling fuel delivery in the fuel lane.

9. The method of claim 1, further comprising the step of using the RF communication link between the fuel vendor and the vehicle to send telematics data from the vehicle to the fuel vendor that can be used to verify that the vehicle has not moved away from the fuel lane, thereby enabling the fuel vendor to disable the fuel dispenser if the vehicle does move away from the fuel lane.

10. The method of claim 1, further comprising the step of conveying at least one of the following types of data from the vehicle to the fuel vendor over the RF communication link:
(a) operational data collected at the vehicle,
(b) mileage data for the vehicle;
(c) engine hour data for the vehicle;
(d) fault code data for the vehicle;
(e) fuel use data for the vehicle; and
(f) fuel tank level data for the vehicle.

11. A method for administering a fuel authorization program for a fuel vendor providing fuel for a vehicle, the method comprising the steps of:
(a) receiving an infrared (IR) transmission from a vehicle in a fuel lane with an IR receiver disposed at the fuel lane, thereby informing the fuel vendor of the identity of the fuel lane the vehicle will use to refuel;
(b) receiving verification data from the vehicle over a radiofrequency (RF) data link, the verification data enabling the fuel vendor to verify that the vehicle is enrolled in the fuel authorization program; and
(c) after determining the vehicle is enrolled in the fuel authorization program and is authorized to receive fuel, enabling fuel delivery at the identified fuel lane, so long as the vehicle remains in the fuel lane.

12. The method of claim 11, further comprising the steps of:
(a) detecting the presence of the vehicle in the fuel lane; and
(b) transmitting an RF query from the fuel vendor to the vehicle in response to detecting the presence of the vehicle, the RF query prompting the vehicle for the IR transmission.

13. The method of claim 11, wherein the step of receiving the IR transmission from the vehicle comprises the step of receiving an IR transmission that provides data enabling an encrypted RF communication link with the vehicle to be established.

14. A non-transitory memory medium having machine instructions stored thereon for facilitating a transaction with a vehicle, the machine instructions, when implemented by a processor, carrying out the functions of:
(a) in response to receiving a wireless transmission from a vehicle that identifies a fuel lane in which the vehicle is present, establishing an encrypted radiofrequency (RF) communication link with the vehicle to verify that the vehicle is enrolled in the fuel payment program; and
(b) after verifying that the vehicle is enrolled in the fuel payment program, conveying a request to enable fuel delivery at the identified fuel lane to a fuel pump controller.

15. The non-transitory memory media of claim 14, wherein the machine instructions, when implemented by a processor, further carry out the function of establishing the encrypted RF communication link with the vehicle by implementing the following functions:
(a) attempting to decrypt an RF communication from the vehicle using a current decryption key; and
(b) if decryption using the current decryption key fails, attempting to decrypt the RF communication from the vehicle using older versions of the decryption key, a number of older versions of the decryption key for which decryption attempts will be made being predefined.

16. The non-transitory memory media of claim 14, wherein the machine instructions, when implemented by a processor, further carry out the function of transmitting an RF query to the vehicle in response to detecting the presence of the vehicle in the fuel lane, such that the wireless transmission from the vehicle that identifies the fuel lane in which the vehicle is present is received in response to the RF query.

17. A method for verifying that a vehicle is enrolled in a fuel authorization program, the method comprising the steps of:
(a) transmitting an infrared (IR) transmission from the vehicle to an IR receiver disposed in a fuel lane, to indicate to a fuel vendor the fuel lane in which the vehicle is present; and
(b) establishing a radiofrequency (RF) communication link between the fuel vendor and the vehicle to verify that the vehicle is enrolled in the fuel authorization program.

18. The method of claim 17, wherein the step of transmitting the IR transmission from the vehicle to the IR receiver disposed in the fuel lane is implemented in response to the vehicle receiving an RF query from the fuel vendor.

19. The method of claim 17, wherein the step of transmitting the IR transmission from the vehicle to the IR receiver disposed in the fuel lane is implemented in response to determining that a location of the vehicle generally corresponds with a location of the fuel lane.

20. The method of claim 17, wherein the step of establishing the RF communication link between the fuel vendor and the vehicle comprises the step of acquiring verification data from a non-transitory memory in the vehicle that is not readily removable, such that receipt of the verification data by the fuel vendor indicates that the vehicle is enrolled in the fuel authorization program, rather than being a non-authorized vehicle attempting to masquerade as an enrolled vehicle by using an authorization component readily removed from an enrolled vehicle.

21. The method of claim 17, wherein the RF communication link is encrypted, and further comprising the step of transmitting at least one of the following types of data from the vehicle over the encrypted RF communication link:
(a) the vehicle's vehicle identification number (VIN);
(b) mileage data;
(c) engine hour data;
(d) fault code data;
(e) fuel use data; and
(f) fuel tank level data.

22. A fuel island for refueling a vehicle, the fuel island comprising:
(a) a fuel dispensing device;
(b) an infrared (IR) receiver configured to receive an IR transmission from a vehicle disposed proximate the fuel dispensing device;
(c) a radio frequency (RF) transmitter for establishing an RF data link between the fuel lane and a vehicle disposed proximate the fuel dispensing device; and
(d) a controller configured to implement the following functions:
(i) in response to receiving an IR transmission from a vehicle disposed proximate the fuel dispensing device, establishing an RF communication link with the vehicle to verify that the vehicle is enrolled in a fuel authorization program; and
(ii) after verifying that the vehicle is enrolled in the fuel authorization program, conveying a request to enable fuel delivery at the fueling dispensing device to a fuel pump controller.

23. The fuel island of claim 22, further comprising a motion detector for detecting a vehicle proximate the fuel dispensing device, and wherein the controller is further configured to implement the function of transmitting an RF query to the vehicle proximate the fuel dispensing device in response to detection of the vehicle, the RF query prompting the vehicle to convey the IR transmission.

24. The fuel island of claim 23, wherein the controller is further configured to disable fuel delivery by the fuel dispensing device upon detecting that the vehicle has moved away from the fuel dispensing device.

25. The fuel island of claim 22, wherein the controller is configured to establish an encrypted RF communication link with the vehicle by implementing the following functions:
(a) attempting to decrypt an RF communication from the vehicle using a current decryption key; and
(b) if decryption using the current decryption key fails, attempting to decrypt the RF communication from the vehicle using older versions of the decryption key, a number of older versions of the decryption key for which decryption attempts will be made being predefined.

26. The fuel island of claim 22, wherein the controller is further configured to disable the fuel dispenser in response to receiving telematics data from the vehicle that indicates that the vehicle has moved away from the fuel lane.

27. A vehicle refueling system for authorizing enrolled vehicles to receive fuel, the system comprising:
(a) a refueling station comprising:
(i) a fuel dispenser configured to dispense fuel when enabled;
(ii) a motion sensor configured to detect the presence of a vehicle proximate the fuel dispenser;
(iii) an infrared (IR) receiver configured to receive IR transmitted data from an enrolled vehicle disposed proximate to the fuel dispenser;
(iv) a radiofrequency (RF) component configured to communicate with an enrolled vehicle disposed proximate to the fuel dispenser; and
(v) a controller configured to implement the functions of:
(A) transmitting an RF query in response to detecting the presence of a vehicle proximate to the fuel dispenser;
(B) in response to receiving an IR transmission from the vehicle proximate to the fuel dispenser, establishing an encrypted RF communication link with the vehicle to verify that the vehicle is enrolled in a fuel authorization program; and
(C) after verifying that the vehicle is enrolled in the fuel authorization program, conveying a request to a fuel pump controller to enable the fuel dispenser; and
(b) an enrolled vehicle authorized to receive fuel, comprising:
(i) an RF component capable of establishing an RF data link with the refueling station's RF component;
(ii) an IR transmitter capable of transmitting data to the refueling station's IR receiver disposed proximate the fuel dispenser; and
(iii) a controller configured to implement the following functions:
(A) in response to receiving the RF query from the refueling station's RF component, transmitting an IR transmission from the vehicle to the refueling station's IR receiver disposed proximate the fuel dispenser, to identify a particular fuel dispenser to be used to refuel the vehicle; and
(B) establishing an encrypted RF communication link between the refueling station and the vehicle to verify that the vehicle is enrolled in the fuel authorization program.

28. A vehicle configured to participate in a fuel authorization program, the vehicle comprising:
(a) a radiofrequency (RF) transmitter capable of establishing an RF data link with a fuel vendor controlling a fuel pump that can be used to refuel the vehicle;
(b) an infrared (IR) transmitter capable of transmitting IR data to an IR receiver disposed proximate a fuel pump used to refuel the vehicle; and
(c) a controller configured to implement the following functions:
(i) establishing an IR communication link between the fuel vendor and the vehicle to confirm in which fuel lane the vehicle is present; and
(ii) establishing an RF communication link between the fuel vendor and the vehicle to verify that the vehicle is enrolled in the fuel authorization program.

29. The vehicle of claim 28, wherein the controller is further configured to transmit at least one of the following types of data from the vehicle over the RF communication link:
(a) the vehicle's vehicle identification number (VIN);
(b) mileage data;
(c) engine hour data;
(d) fault code data;
(e) fuel use data; and
(f) fuel tank level data.

30. The vehicle of claim 28, further comprising a first indicator lamp and a second indicator lamp, the first indicator lamp being configured to inform a driver of the vehicle that the IR transmitter is properly positioned relative to an IR receiver associated with a fuel pump, and the second indicator lamp being configured to inform the driver that the IR data has been successfully conveyed, such that the vehicle can be moved relative to the fuel pump to place the fuel pump and a vehicle fuel tank in close enough proximity to enable refueling to occur.

31. The vehicle of claim 28, wherein the controller is part of a removable accessory component, and the controller is further configured to verify that the vehicle is enrolled in the fuel authorization program by acquiring data uniquely identifying the vehicle from a non-transitory memory that is not readily removable from the vehicle, such that removing the accessory component and placing the accessory component in a non-enrolled vehicle will not enable the non-enrolled vehicle to participate in the fuel authorization program.

32. The vehicle of claim 28, wherein the controller is further configured to verify that the vehicle is enrolled in the refueling program by acquiring verification data from a non-transitory memory in the vehicle that is not readily removable, such that receipt of the verification data by the fuel vendor indicates that the vehicle from which the verification data is received is enrolled in the fuel authorization program, rather than being a non-authorized vehicle attempting to masquerade as an enrolled vehicle by using an authorization component readily removed from an enrolled vehicle.

33. The vehicle of claim 28, wherein the controller is further configured to implement the function of using the RF communication link between the fuel vendor and the vehicle to send telematics data from the vehicle to the fuel vendor that can be used to verify that the vehicle has not moved away from the fuel dispenser, thereby enabling the fuel vendor to disable the fuel dispenser if the vehicle does move away from the fuel dispenser.

34. The vehicle of claim 28, wherein the controller is further configured to establish the IR data link in response to receiving a radio frequency (RF) query from the fuel vendor.

35. The vehicle of claim 28, wherein the controller is further configured to establish the IR data link in response to determining that a location of the vehicle generally corresponds to a location of the fuel vendor.

36. A method for verifying that a vehicle is enrolled in a fuel authorization program, the method comprising the steps of:
(a) reading a radiofrequency identification (RFID) tag disposed at a fuel lane using an RFID tag reader logically coupled to a controller in the vehicle; and
(b) wirelessly transmitting data from the vehicle to a fuel vendor, the data including:
(i) RFID tag data acquired from the RFID tag disposed at the fuel lane, the RFID tag data identifying the fuel lane from which the vehicle is to receive fuel; and
(ii) verification data from the vehicle that can be used to verify that the vehicle is enrolled in the fuel authorization program, the verification data including a data component that is acquired from a non-transitory memory in the vehicle that is not readily removable, such that receipt of the verification data by the fuel vendor indicates that the vehicle from which the verification data is received is an enrolled vehicle, rather than being a non-authorized vehicle attempting to masquerade as an enrolled vehicle by using a component readily removed from an enrolled vehicle.

37. The method of claim 36, wherein the verification data transmitted from the vehicle to the fuel vendor includes encryption data that is available only to participants in the fuel authorization program, such that receipt of the encryption data by the fuel vendor indicates that the vehicle from which the verification data is received is an enrolled vehicle, rather than being a non-authorized vehicle attempting to masquerade as an enrolled vehicle by using a component removed from an enrolled vehicle.

38. The method of claim 36, wherein the step of reading the RFID tag is implemented in response to the vehicle receiving an RF query from the fuel vendor.

39. A method for administering a fuel authorization program for a fuel vendor operating a plurality of fueling lanes, the method comprising the steps of:
(a) detecting the presence of a vehicle in a specific fueling lane;
(b) transmitting a wireless query to the vehicle in response to detecting the presence of the vehicle;
(c) receiving a wireless transmission from the vehicle, the transmission identifying the specific fueling lane in which the vehicle is present;
(d) establishing a wireless encrypted communication link with the vehicle to verify that the vehicle is enrolled in the fuel authorization program; and
(e) after determining the vehicle is enrolled in the fuel authorization program and is authorized to receive fuel, enabling fuel delivery at the identified fueling lane, so long as the vehicle remains in the specific fueling lane.

40. A module to be installed at a fuel lane to enable the fuel lane to participate in a fuel authorization program, the module comprising:
(a) a housing;
(b) an infrared (IR) receiver configured to receive an IR transmission from a vehicle disposed proximate the fuel lane;
(c) a radio frequency (RF) transmitter for establishing an RF data link between the fuel lane and a vehicle disposed proximate the fuel dispensing device; and
(d) a controller configured to implement the following functions:
in response to receiving an IR transmission from a vehicle disposed proximate the fuel lane, establishing an RF communication link with the vehicle to verify that the vehicle is enrolled in a fuel authorization program; and
(ii) after verifying that the vehicle is enrolled in the fuel authorization program, conveying a request to enable fuel delivery at the fuel lane to a fuel pump controller.

41. The module of claim 40, further comprising a motion detector for detecting a vehicle proximate the fuel lane, and the controller is further configured to implement the function of transmitting an RF query to the vehicle proximate the fuel lane in response to detection of the vehicle, the RF query prompting the vehicle to convey the IR transmission.

42. The module of claim 41, wherein the controller is further configured to disable fuel delivery by a fuel dispensing device upon detecting that the vehicle has moved away from the fuel lane.

43. The fuel island of claim 40, wherein the controller is further configured to disable the fuel dispenser in response to receiving telematics data from the vehicle that indicates that the vehicle has moved away from the fuel lane.

44. A vehicle configured to participate in a fuel authorization program, the vehicle comprising:
(a) a radiofrequency (RF) transmitter capable of establishing an RF data link with a fuel vendor controlling a fuel pump that can be used to refuel the vehicle;
(b) a non-transitory memory in which verification data is stored, the verification data enabling a fuel vendor to verify that the vehicle is enrolled in the fuel authorization program, the non-transitory memory being incorporated into the vehicle such that the non-transitory memory cannot be readily removed and moved to a different vehicle; and
(c) a controller configured to implement the following functions:
(i) access the verification data in the non-transitory memory in response to a request for verification data; and
(ii) use the RF transmitter to convey the verification data to the fuel vendor, the verification data enabling the fuel vendor to verify that the vehicle is enrolled in the fuel authorization program, such that receipt of the verification data by the fuel vendor indicates that the vehicle from which the verification data is received is enrolled in the fuel authorization program, rather than being a non-authorized vehicle attempting to masquerade as an enrolled vehicle by using a component readily removed from an enrolled vehicle.

45. The vehicle of claim 44, further comprising an infrared (IR) transmitter logically coupled to the controller, and wherein the controller is further configured to use the IR transmitter to respond to a query from the fuel vendor, the IR transmission from the vehicle indicating to the fuel vendor an identity of the fuel pump from which the vehicle is to use to refuel.

46. The vehicle of claim 44, further comprising an infrared (IR) transmitter logically coupled to the controller, and wherein the controller is further configured to use the IR transmitter to convey data identifying the vehicle to a fuel vendor in response to determining that a location of the vehicle generally corresponds to a location of the fuel vendor.

47. The vehicle of claim 44, further comprising a radiofrequency (RFID) tag reader logically coupled to the controller, and the controller is further configured to implement the functions of:
(a) use the RFID tag reader to read an RFID tag disposed at the fuel lane; and
(b) use the RF transmitter to convey to the fuel vendor RFID tag data acquired from the RFID tag disposed at the fuel lane, the RFID tag data identifying the fuel lane from which the vehicle is to receive fuel.
